(19) United States
(12) Patent Application Publication
(10) Pub. No.: US 2006/0005124 A1
(43) Pub. Date: Jan. 5, 2006

(54) User interface for complex process implementation

(76) Inventor: Ewald Speicher, Saarbruecken (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/153,425

(22) Filed: Jun. 16, 2005

Related U.S. Application Data
(60) Provisional application No. 60/579,664, filed on Jun. 16, 2004.

(51) Int. Cl. G06F 15/00

(52) U.S. Cl. 715/514

(57) ABSTRACT

Computer-generated user interfaces, systems and methods are provided for use in a process implementation environment. In one exemplary embodiment, the user interface may comprise of a first area for displaying a hierarchical structure, the hierarchical structure defining of one or more processes and being navigated by a user to select among the one or more processes. The user interface may also comprise of a second area for displaying one or more actions, wherein the actions are user-selectable and are displayed in the second area based on the process selected by the user.

### CROSS REFERENCE TO RELATED APPLICATION

This application claims the benefit of priority to U.S. Provisional Patent Application No. 60/579,664 entitled, “User Interface for Complex Process Implementation,” filed Jun. 16, 2004, the disclosure of which is expressly incorporated herein by reference to its entirety.

### TECHNICAL FIELD

The present invention generally relates to user interfaces for facilitating process review and implementation. More particularly, the invention relates to computer-generated user interfaces for supporting complex process implementation.

### BACKGROUND

Business processes are the driving factors of a success-oriented company. On the operational level, business processes are a description of consecutive functions or activities in order to create added value (e.g., order management). Successful companies design their processes with the help of modeling tools and applications which depict, analyze and optimize the correlation of the entire process. In fact, these such systems are often a prerequisite for complying with standard-related or statutory requirements, such as ISO 9001, KontraG, etc.

Know modeling approaches suffer from one or more drawbacks. For instance, if business processes are implemented operatively, the correlation of the entire process may be lost. This is because the application systems that are used to support them are designed with other aspects in mind.

Conventional user interfaces of application systems are function-oriented: i.e., the user selects a function (e.g., “Mail Management”, “Personnel Master Data Management,” etc.) and then selects the object (e.g., employee) to which the function relates. The correlation of the function with the entire process cannot be recognized. The division of the system into functional blocks without any reference to the process dominates the design of the user interface of the application. At the operational level, this may result in an inadequate process orientation and, therefore, also in inefficient operation.

A process-driven design of application systems requires a user interface that visually embeds all the functions in the process from the correlation of which they alone are meaningful. The process itself and its description should be present in functions at any time. If functions and a process description are combined to form the collective concept of action dimensions, this results in a three-stage division:

Process Step->Action Dimension->Object (Optional).

There are four basic requirements to be met by the design of such a user interface: process orientation; full integration of all functions in the process step; focus on the essentials; and uniform orientation for the user.

Under process orientation, all activities within the framework of executing the business process orientate themselves by the process. The process is therefore the central element by which the work steps orientate themselves. It must therefore also become the leading principle for the interface design. Processes are hierarchically structured, and the process steps are executed in a defined order. The user interface must enable the user to intuitively recognize both the hierarchical structure and the order of process steps (i.e., without the need for further explanations). This results in the requirement for a uniform and constantly available representation of the process structure.

Functions are possible actions that are provided at a process step. They are dependent on the process step and are therefore dynamic (i.e., type and scope vary depending on the process step). There are also static possible actions that are meaningful for every (or most) process step(s)—irrespective of the other functions (e.g., the documentation of the process step from process modeling, the process image, planning information about the process step). The interface may be designed in such a way that all the possible actions can be depicted and that the user can very easily switch between the possible actions. Each possible action must be embedded in a complete context, in which all the information and possible interactions which belong to a complete action are present. A complete possible action in this sense is mapped by an action dimension. Action dimensions of a process step are categorized (e.g., all the descriptions of a process step belong to the action dimension type “process description”). The action dimension therefore describes the type of function. All action dimensions of the same type have the same identifier and are represented in a uniform manner by the user interface.

Information that is of minor relevance to a process step is not displayed to the user. In particular, this means that whenever an action dimension has either no or little relevance to the process step, it is hidden (e.g., if planning information is not relevant for a process step, this dimension is hidden). Whenever the action dimension does not know the objects on which functions are carried out, there is no object structure; in particular, this means no “empty” object windows. This means that the type and number of dimensions that are shown for each process step may vary from step to step.

Under uniform orientation, the user needs to move in a complex action framework of processes, action dimensions and objects on which these actions can be carried out. It is therefore very important that the user is always orientated in a uniform manner by the coordination point at which he or she is located within the system. In each action area (process, action dimensions, work objects), exactly one object should always be selected (has the focus) and this is should always be displayed (principle of focus marking). Wherever possible, the selected object should remain constant in the action area, unless the user explicitly selects a different object. However, the focus in the action areas, wherever possible, should still remain constant (principle of focus constancy).

The conventional design of application systems does not provide a reference to the business process which uses the system as a tool. There is a huge gap between the design of the business flows as processes and the implementation of these processes at the operational level. The understanding of the correlation and efficient handling of the process is lost. Moreover, a great deal of effort is required to provide proof of process-compliant handling of business transactions. For this reason, a user interface whose design directly creates this correlation is required. Further, there is a need for process-oriented handling of business processes to create quality and efficiency in the procedure of the operational level, which was the original design objective.

### SUMMARY OF THE INVENTION

Systems, methods and computer-readable media consistent with embodiments of the present invention may obviate one or more of the above and/or other issues and drawbacks. Consistent with an aspect of the invention, computerized systems and methods may be provided for enabling complex process review and implementation, such as for business processes.

In accordance with one embodiment, a computer-generated user interface is provided for use in a software application system. The computer-generated user interface may comprise a first area for displaying a hierarchical structure, the hierarchical structure defining one or more processes and being navigated by a user to select among the one or more processes. The computer-generated user interface may also comprise a second area for displaying one or more actions, wherein the actions are user-selectable and are displayed in the second area based on the process selected by the user.

In accordance with another embodiment, a computer-generated user interface for use in a process implementation environment is provided. The user interface may comprise a first area for displaying a hierarchical structure, the hierarchical structure defining of one or more processes and being navigated by a user to select among the one or more processes; and a second area for displaying one or more actions, wherein the actions are user-selectable and are displayed in the second area based on the process selected by the user.

In accordance with another embodiment, a computerized method for implementing a process using a computer-generated user interface is provided. The method may comprise identifying a process within a hierarchical structure in a first area, the hierarchical structure defining one or more processes and being navigated by a user to select among the one or more processes, and displaying one or more actions based on the identified process in a second area, wherein the actions are user-selectable.

In accordance with yet another embodiment, a computer-readable medium containing instructions for controlling a computer system to perform a method for implementing a business process. The computer system may have a processor for executing the instructions, the method comprising identifying a process within a hierarchical structure in a first area, the hierarchical structure defining one or more processes and being navigated by a user to select among the one or more processes; and displaying one or more actions based on the identified process in a second area, wherein the actions are user-selectable.

Additional embodiments and aspects of the invention are set forth in the detailed description that follows or may be learned by practice of methods, systems, and articles of manufacture consistent with the present invention. It is understood that both the foregoing general description and the following detailed description are exemplary and explanatory only, and are not restrictive of embodiments of the invention, as claimed.

### BRIEF DESCRIPTION OF THE DRAWINGS

The accompanying drawings, which are incorporated in and constitute a part of this specification, illustrate several aspects of the invention and, together with the description, serve to explain the principles of the invention. In the drawings:

FIG. 1A illustrates an exemplary modeling environment for implementing embodiments of the present invention;

FIG. 1B illustrates a flow diagram of an exemplary process, consistent with the present invention;

FIG. 2 illustrates an exemplary process implementation system, consistent with the present invention;

FIG. 3 is an exemplary GUI for a process implementation system, consistent with the present invention;

FIG. 4A is an exemplary GUI illustrating an expansion of an element, consistent with the present invention;

FIG. 4B is an exemplary GUI illustrating a process element in a tree, consistent with the present invention;

FIGS. 5A and 5B are two other exemplary GUIs for a process implementation system, consistent with the present invention;

FIG. 6 is an exemplary GUI for entering the data of the generated structure item;

FIG. 7 is an exemplary GUI showing how to modify process step properties, consistent with the present invention;

FIG. 8 is an exemplary GUI showing a structure of the detailed area, consistent with the present invention;

FIG. 9 is another exemplary GUI for a process implementation system, consistent with the present invention;

FIG. 10 is an exemplary GUI of a process image, consistent with the present invention;

FIG. 11 is an exemplary GUI of a process image step, consistent with the present invention;

FIG. 12 is a exemplary GUI of a process step description, consistent with the present invention;

FIG. 13 is an exemplary GUI of a standard functional cover “Planning” with the data fields for planning and feedback of the completion progress of the process element, consistent with the present invention;

FIG. 14 is an exemplary GUI of a work dimension “Documents” with an empty list of documents and the selection of assigned document templates, consistent with the present invention;

FIG. 15 is an exemplary GUI of a design stage of a template, consistent with the present invention;

FIG. 16 is an exemplary GUI of a process design into the list of templates for this process step, consistent with the present invention;

FIG. 17 is an exemplary GUI of a dimension “Additional Information,” consistent with the present invention;

FIG. 18 is an example of a process step with a specific functional cover with two elements, consistent with the present invention;

FIG. 19 is another example of a process step with a specific functional cover with three elements, consistent with the present invention;

FIG. 20 is an exemplary GUI of a action dimension “Project Profile,” consistent with the present invention;

FIG. 21 is an exemplary GUI of embedding of the list of connectors in a action dimension Process Step Description, consistent with the present invention;

FIG. 22 is an exemplary GUI of a process step with a list of connectors with three segments (tools, templates, examples), consistent with the present invention;

FIG. 23 is an exemplary GUI of the relationship between connectors in the process design and within the action dimension description, consistent with the present invention;

FIG. 24 provides exemplary GUIs showing a marker within the list of connectors, consistent with the present invention;

FIG. 25 is an exemplary GUI of a connector, consistent with the present invention;

FIG. 26 is an exemplary illustration of a mode of operation of the connector type “original hyperlink,” consistent with the present invention;

FIG. 27 is an exemplary illustration of a case of connectors that represent templates, consistent with the present invention;

FIG. 28 is an exemplary illustration of an Intranet or HTML form that is opened; and

FIG. 29 is an exemplary illustration of a route for process design using exemplary files.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations, and other implementations are possible, without departing from the spirit and scope of the invention. For example, substitutions, additions, or modifications may be made to the components illustrated in the drawings, and the exemplary methods described herein may be modified by substituting, reordering, or adding steps to the disclosed methods. Accordingly, the following detailed description does not limit the invention. Instead, the proper scope of the invention is defined by the appended claims.

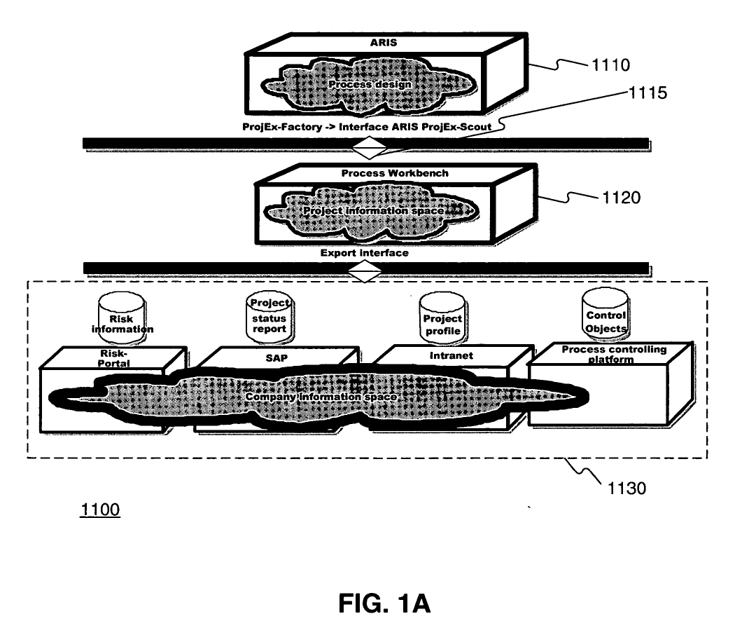

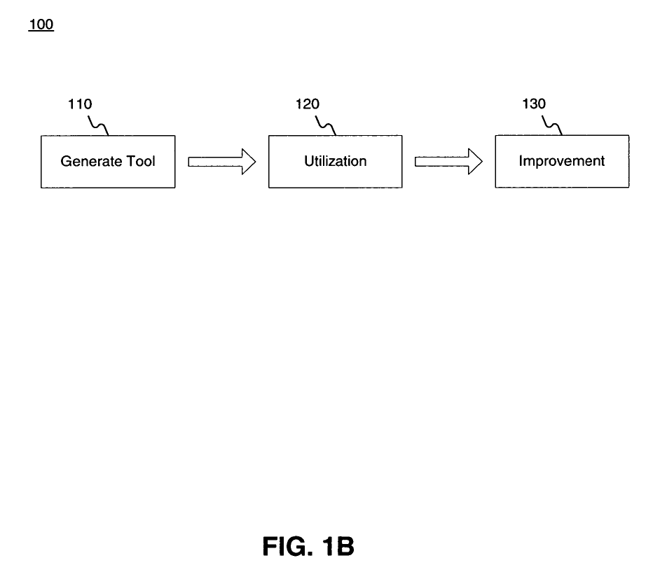

FIG. 1A illustrates an exemplary modeling environment 1100 for implementing embodiments of the invention. As shown in FIG. 1A, modeling environment 1100 may include a process design module 1110, a process workbench 1120, and a business entity information space 1130. System 1100 may, in at least one example, include functional logic to implement one or more of methods and/or other aspects consistent with the present invention.

Process design module 1110 may be implemented by one or more software, hardware, and/or firmware components and may leverage one or more logical components, processes, algorithms, systems, applications, and/or networks. Process design module 1110 may establish, design, and document business processes associated with a business entity.

Process workbench 1120 may include one or more software, hardware, and/or firmware components and may leverage one or more logical components, processes, algorithms, systems, applications, and/or networks. Process workbench 1120 may include functionality associated with, for example, a business process implementation tool (BPIT) (cf. FIG. 1B) that provides documentation of business processes associated with a business entity and facilitates efficient implementation of those documented processes. Process workbench 1120 may provide access to process information at process runtime. Process workbench 1120 may export data to various applications that administer the logical information space of a business entity. In addition, process workbench 1120 may serve as an input interface for basic business entity data, such as employee data, project data, financial data, etc.

Process workbench 1120 may interface process design module 1110 via a process interface 1115. Process interface 1115 may be part of process workbench 1120 and/or process design module 1110. Process interface 1115 may generate XML files that are imported by process workbench 1120 and may build an application framework for business processes. Exemplary systems and methods for integrating business process documentation with working environments is described in a concurrently filed, U.S. patent application entitled “Systems and Methods for Integrating Business Process Documentation with Work Environments,” Attorney Docket No. 09268.0004-00, which is expressly incorporated herein by reference to its entirety.

In addition to integrating business process documentation with working environments, process workbench 1120 may also include one or more software modules or components for implementing a user interface or GUIs, consistent with embodiments of the present invention. The user interface provided as part of process workbench 1120 may be implemented consistent with the features and aspects disclosed herein for enabling process review and implementation. Within the software architecture of process workbench 1120, the user interface may be provided alone or along with other user interfaces (such as for workbench functionality). It is also possible to implement a user interface consistent with the invention in other components of environment 1100.

Business entity information space 1130 may include one or more software, hardware, and/or firmware components and may leverage one or more logical components, processes, algorithms, systems, applications, and/or networks. Information space 1130 may include various data associated with a business entity. Further, business entity information space 1130 may include one or more knowledge bases associated with a business entity. As used herein, the term “knowledge base” refers to any repository, resource, facility, or lexicon, operable to maintain and access information, such as numeric information, textual information, audible information, graphical information, etc. The knowledge bases may include one or more structured data archives distributed among one or more network-based data processing systems. In one example, a knowledge base may include one or more relational databases and management systems (e.g., Oracle databases, DB2, MS SQL, etc.). In addition, a knowledge base may leverage one or more elements from a storage area network (SAN). A particular knowledge base may be multidimensional in that it may organize data hierarchically and across several dimensions. In one implementation, a given knowledge base may be configured to provide data warehousing functions for a business entity.

Business entity information space 1130 may also include one or more resources for implementing business processes. For example, business entity information space 1130 may include application systems, IT infrastructure components, documents, knowledge bases, etc.

To further illustrate environments and processes in which aspects and features of the invention may be realized, FIG. 1B provides a flowchart 100 of an exemplary business process implementation tool lifecycle. As illustrated in FIG. 1B, the lifecycle may include generating a business process implementation tool (stage 110), enabling tool utilization (stage 120), and enabling tool improvement (stage 130).

As described above, a business process implementation tool (BPIT) may be generated (stage 110). The BPIT may be implemented as a workbench (cf. module 1120 of FIG. 1A) and provide documentation of business processes associated with a business entity and facilitate efficient implementation of those documented processes. As used herein, the term “business process” refers to any related group of activities that produce an output associated with a value-related goal. A business process “activity” may include any operation, procedure, task, process step, transaction, initiative, and/or sequence of actions performed in order to achieve the business process goal. Business process activities may be computer-performed and/or performed by one or more individuals (e.g., executives, workforce, customers, etc.). A sequence of activities that execute a specific goal or task associated with a business process may be referred to as a “work process.”

Business processes may be associated with one or more “business entities,” which may include enterprises organizations, corporations, partnerships, firms, enterprises, service providers, manufacturers, suppliers, distributors, wholesalers, retailers, educational institutions, government agencies, and the like. A business process may be developed within a single business entity and implemented either within a single business entity or across several business entities. In addition, business processes could be collaboratively developed among several business entities.

A BPIT may be generated for pre-established business processes associated with a business entity. Establishing a business process may include designing the business process, collecting and managing knowledge, designating responsible parties, and establishing various resources necessary for process implementation. Establishing a business process may also include generating various descriptions, such as process activity descriptions, descriptions of responsible parties, and descriptions of resources for implementing the process.

Depending on the particular business entity and business process, business process descriptions may be integrated in a business entity's management system. A “management system” refers to any system used by a business entity for managing internal activity (e.g., quality, security, etc.) A “management system” may document regulations, procedures, responsibilities, etc. for meeting objectives in a certain area. One example of a management system is a quality management system, which may document regulations, procedures, and responsibilities associated with quality assurance. By way of further example, management systems may include systems that comply with the ISO 9000:2000 international standard.

A business entity may establish business processes using various modelling tools, such as those available in the ARIS Toolset provided by IDS Scheer AG (Saarbruecken, Germany). In one example, the business processes may be described using the eEPK presentation standard in the ARIS Toolset.

The BPIT may serve as a workbench that integrates business process documentation with resources for implementing the business process, such that a user can navigate the process and efficiently execute the process using the resources. Business process “documentation” refers to a systematic representation of a business process. Such representations may include various forms of visual and audible information, such as text, graphics, symbols, audio signals, video signals, holographic images, etc. The business process “documentation” may be generated based on pre-existing knowledge, descriptions, and representations associated with a business process, such as information included in management systems and/or established by process modeling and design tools (e.g., ARIS).

A “resource” for implementing a business process refers to any application, system, or element that implements or executes an activity associated with a business process. Resources for implementing a business process may include one or more elements included in or coupled to IT infrastructures, information systems, logistics systems, financial infrastructures and accounting systems, procurement systems, operations systems, human resource systems, customer interface systems, storage networks and infrastructures, etc. Resources may include electronic documents, electronic templates from which documents can be generated, masks in application systems (e.g., in SAP R/3), Intranet information (in various forms), Internet resources, e-mails, telephone, fax, appointment planners, etc. Resources may also include and/or utilize one or more of workflow software, CRM (customer relationship management) systems, ERP (enterprise resource management) systems, EAI (enterprise application integration) tools, CIM (Computer Integrated Manufacturing) tools, SCM (Supply Chain Management) systems, customer-, supplier-, and/or internal-oriented e-Business applications, and any other business-related applications and/or intelligence.

To further illustrate the relation between business processes and resources, consider the following example. Assume a business process X includes a {Calculate Offer} activity, which must be executed by employee A. In order for employee A to carry out the activity (i.e., calculate the offer), employee A might need to access various resources, such as a price list, information in a database (e.g., addresses, product identifiers, etc.), information on a disk drive, an Intranet or the Internet. These resources may be dispersed throughout the employer's infrastructure. Generating the BPIT (stage 110) may involve documenting the business process X, including the {Calculate Offer} activity, integrating the documentation with the various resources for implementing the business process (e.g., databases, Intranet, etc.), and providing a workbench through which employee A can access and navigate the documented process and efficiently access the resources needed for implementing the {Calculate Offer} activity.

Once the BPIT is generated (110), the BPIT may be utilized (120). The BPIT may present in a user's working environment (e.g., a computer workstation) a “navigation structure” representing a business process documentation. The presented business process may be linked with the necessary resources for executing the process, as well with descriptions of the individual business process activities and work processes. The BPIT may allow users to navigate the process and access the documentation and resources through the navigation structure.

Consistent with embodiments of the invention, one or more user interfaces or GUIs may be provided to facilitate utilization of the BPIT (stage 120). In at least one example, a user interface may be provided in a user's working environment that facilitates access to the BPIT. Providing a user interface may involve establishing and/or configuring one or more websites maintained by one or more computer systems. The user interface may enable users to identify, access, manipulate, and view business processes, as well as access documentation and resources for implementing processes. Exemplary user interfaces and other features for process implementation are further described herein.

Referring again to FIG. 1B, once a generated BPIT has been utilized by a business entity, and business process instances have been generated, the BPIT may be improved (130). Improving a BPIT may involve analyzing a business process to determine whether aspects of the BPIT should be modified. Analyzing business processes may involve measuring business process performance and facilitating business process management and improvement. Measuring business process performance may include calculating one or more performance indicators, such as KPIs (key performance indicators) based on recorded instances of documented business processes. Performance indicators may include measurable and/or calculable properties of business processes and their functions (i.e., activities). Performance indicators may measure time, cost, quality of service, volume, reliability, etc. Performance indicators may be differentiated according to established or configurable dimensions, which may be based on time, location, process type, products, customers, documents, etc. Filters may also be specified for use with performance indicators.

Performance indicators may be calculated for every process instance to measure and analyze process performance. The term “process instance” refers to a particular realization of given business process. A process instance may correspond to a business process that has actually been executed. That is, a process instance may represent an actual business activity that has occurred.

In addition, analyzing business processes may involve establishing one or more process instance independent performance indicators and dimensions, which are not calculated from process instance data, but instead from data independent of individual process instances. These indicators may be used to analyze business processes when instance-related data is unavailable.

Analyzing business processes may also include generating trend analyses, business process cycle time analyses, top/flop analyses, yield tables, quartile analyses, customer churn rates, etc. In one example, analyzing business processes may include performing multi-dimensional analyses of information obtained from the resources implementing those processes.

By way of example, improving a BPIT (120) may involve identifying business process activities that require change. Improving a BPIT (120) may also include identifying weaknesses in links between process activities and resources for implementing those activities. Further, identifying activity changes and weaknesses in links may be based on business process analyses.

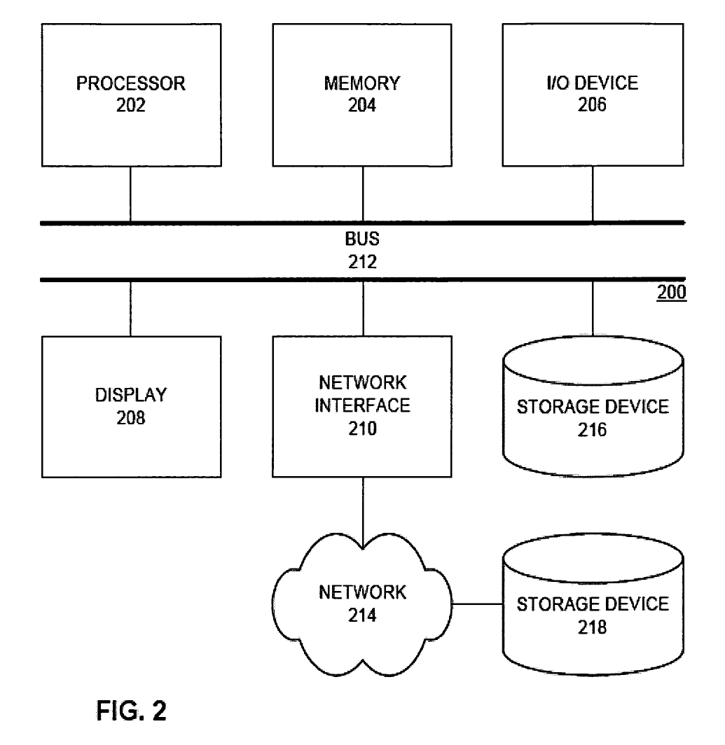

FIG. 2 provides a detailed diagram of an exemplary process implementation system, consistent with an embodiment of the present invention. Process implementation system 200 may include a processor 202, a memory 204, an input/output (I/O) device 206, a display 208, a network interface 210, a bus 212, a network 214, and one or more persistent storage devices 216 and 218. Processor 202, memory 204,1/0 device 206, display 208, network interface 210, and storage device 216 may be configured to communicate over bus 212. Storage device 216 and network interface 210 may be configured to communicate over network 214. In one exemplary embodiment, process implementation system 200 may be incorporated into or with a modeling system, such as the ARIS Toolset available from IDS Sheer AG (Saarbruecken, Germany).

Processor 202 may include a mainframe, a laptop, a personal computer, a workstation, a computer chip, a digital signal processor board, an analog computer, a plurality of processors, or any other information processing device or combination of devices. Further, processor 202 may be implemented by a general purpose computer or data processor selectively activated or reconfigured by a stored computer program, or may be a specially constructed computing platform for carrying out the features and operations disclosed herein. Memory 204 may include random access memory (RAM), read-only memory (ROM), flash memory, or any other information storage device. I/O device 206 may include a keyboard, a mouse, a trackball, a light pen, an electronic tablet, or any other mechanism that can provide information to monitor process implementation system 200. Display 208 may include a cathode-ray-tube monitor, a plasma screen, a liquid-crystal-display screen, or any other device for conveying information from process implementation system 200. Network interface 210 may include an Ethernet card, an FDDI card, a modem, or any other mechanism for interfacing to a network. Bus 212 may include a data cable, a circuit board connection, a fiber optic line, a network, a serial connection, a parallel connection, or any other mechanism for conveying information between processor 202, memory 204,1/0 device 206, display 208, network interface 210, and/or storage device 216. Network 214 may include a local area network, a wide area network, an intranet, an Extranet, the Internet, a telephone network, a wireless network, a wired network, or any other means for communicating between locations. Storage devices 216 and 218 may include a hard drive, a tape drive, a RAID disk array, a database system, an optical disk drive, and/or any other device or system that persistently stores information.

In one exemplary embodiment consistent with the present invention, memory 204 may store a software application or module that generates one or more graphical user interfaces for complex process review and implementation. Examples of such graphical user interfaces are discussed in greater detail below.

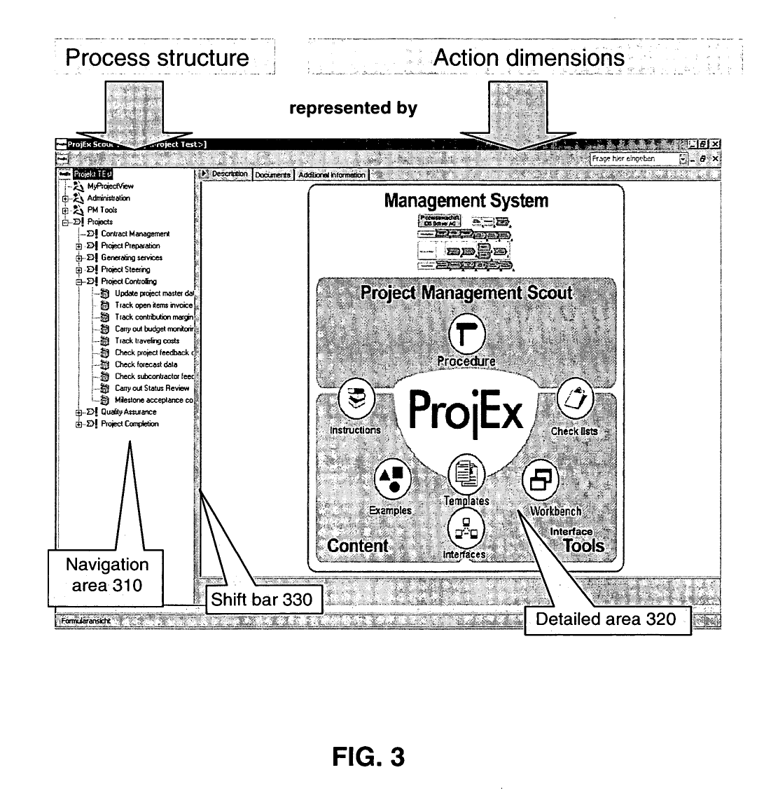

FIG. 3 is an exemplary Graphical User Interface (GUI) that may be created by an process implementation system (such as system 200 of FIG. 2) to use with a modeling system, consistent with an embodiment of the present invention.

In general, one or more user interfaces may be provided for process implementation. Such interfaces may include, for example, entry fields and control buttons for entering information. Further, each GUI may be enabled with message prompts, entry fields and/or control buttons. Such a GUI may comprise one or more screens or windows to guide a user through the set-up and running of a process implementation. Moreover, help screens may provide information for the user and drop-down menus or tables may provide lists of predefined services, profiles and/or other elements for selection by the user when running the process implementation system.

Main Interface

Referring again to FIG. 3, the exemplary GUI interface may be divided into two areas: a process framework or navigation area 310; and process detail page or detailed area 320. In one embodiment, the navigation area 310 and the detailed area 320 together are located in the same position in the user interface present on all pages of tool utilization. For example., the navigator area 320 may be located on the left of the user interface and the detailed area 320 may be located on the right. As one skilled in the art would appreciate, however, the navigator area 310 may also be located on the right hand side, and a vertical division may be used in place of a horizontal division. In another embodiment, the partitions of the interface may also be reconfigured by the user of the process implementation system.

In one exemplary implementation, a user of the process implementation system 200 may select a form in which two independently developed subforms are embedded from database 216. The size proportions are statically predetermined by the size of the controls for the subforms. If the user of the process implementation system 200 selects a different relative position of the navigator area 310 and detail area 320, a different superior form is loaded, where the position of the controls for the subforms is in line with user requirements. The last setting selection of the user is saved as a Registry entry (user-specific system file) and when the form is loaded, forms the user-specific default setting for the loading process (i.e., if the user of the GUI selected a particular layout of the subforms, this layout remains constant for the user until he changes the position at runtime). Additionally, or alternatively, the user may also change the position of the windows at runtime using a simple configuration dialog. When the settings have been changed, the form is closed and is reloaded with the new setting. The new setting is entered in the Registry and made permanent.

In the example of FIG. 3, a shift bar 330 may be provided between the two areas of the interface allows the user to adjust the parts of the interface to the size that he or she requires at any time. The areas are moved, by “grabbing” the shift bar 330, moving the area while keeping the mouse button pressed and then releasing the mouse button when the desired change has been made.

In one embodiment, the shift bar 330 is an area of the superior form. For this area, the events “MouseDown”, “MouseMove” and “MouseUp” are locked. The shift bar 300 is moved in proportion to the horizontal shift of the mouse (which can be calculated from the coordinates of the mouse pointer in the MouseMove event). The horizontal extension of the two subform controls and the loaded forms is adjusted accordingly.

Layout of Navigator

Process elements may represent an entire business process, phases of the process or individual process steps etc. Process elements may be represented in a hierarchical relationship to each other (vertical relationship). Process elements of the same hierarchy level can, on the other hand, be in a sequence-related relationship to each other (one process step follows another; a horizontal relationship). In the navigator (navigation area 310), a depiction of the process structure may be provided to show this relationship of the process elements to each other in an appropriate manner.

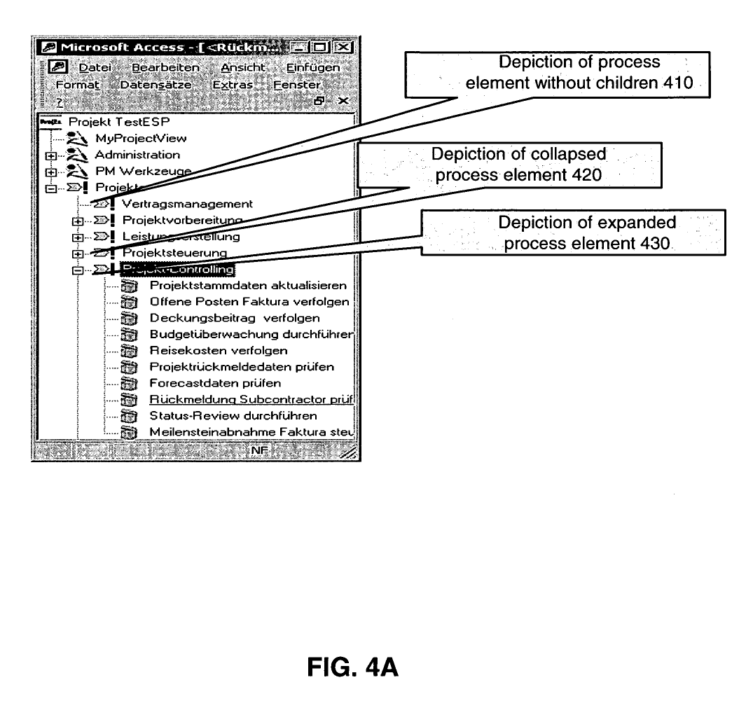

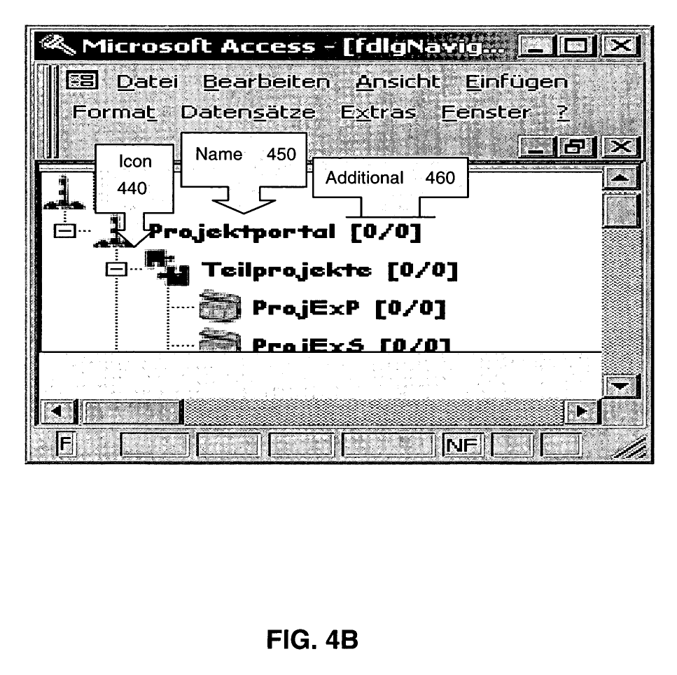

A tree structure as shown in FIG. 3, may be implemented, for example, by the Microsoft Treeview Control. Vertical relations are shown in FIG. 3 by shifts to the right. Horizontal relations are shown by the arrangement of the elements from top to bottom. If an element is moved directly under another element and is shifted to the right, this element is referred to as a “child” (i.e., as a refinement) of the element that is superior to it. Children may also have their own children. A process may also have no children 410, as shown in the example of FIG. 4A.

The concept of expansion of elements may be supported by the process implementation system 200. If an element hides its children, it is said to be “collapsed” 420, if it shows its children, it is said to be “expanded” 430. The state of expansion of an element may be represented graphically in a GUI, such as that shown in the exemplary GUI of FIG. 4A.

FIG. 4B provides another exemplary GUI of a process element in a tree, consistent with embodiments of the present invention. As shown in FIG. 4B, the graphical representation of a process element may include three parts: an icon 440, an identifier/name 450, and any additional information 460. The icon is intended as a pictorial representation of the process element, but also carries “high level” information that enables a quick visual orientation for the user of the process implementation system. The information is a combination of the type of process element (phase, work package, activity), the processing status of the element (active, inactive, critical, completed) and the obligation of the element (with the two statuses optional and mandatory).

In one embodiment, a logical identifier is used as a list entry tag for each icon 440. When the process tree is set-up and whenever information that affects the representation is changed, the element type, activity status, obligation status and criticality status of the process element is sent to a central component, the icon dispatcher (not shown). The icon dispatcher returns the appropriate logical identifier. The logical identifier is searched for in the tags of an ImageList and the index of the icon 440 is linked to the process element. The ImageList may comprise an ordered container of image files (e.g., .gif, .tif files) to be depicted at the user interface. With an ImageList, a user can search an image using a logical identifier (e.g., which are predefined) in the list and obtain it from the list. Such features may be implemented using, for example, Microsoft ImageList control or a similar standard.

The item identifier/name 450 is the name of the process element and may be imported from a modeling tool. Users who are authorized to modify the process tree can adapt the identifier 450. The identifier 450 may displayed in any number of languages.

The additional information 460 can be used as a quick reference for element information that is considered essential by the user. It can be dynamically switched on or off. When selected, it is displayed in angular brackets. By default, the target and actual date are contrasted here. The expense schedule, progress, number of children or combinations of these could, however, also be displayed. The type and scope of additional information 460 to be displayed can be defined by the user at any time via a settings dialog.

Operations in Navigator

A process tree may also be customized to the specific requirements of a concrete process. The process tree is considered as a logical unit, as a structure element. For this reason, the structure of the process tree cannot be modified concurrently.

A user of process implementation system 200 may need assigned rights to be able to adjust the process tree. For purposes of the following example, this user with assigned rights is to be referred to as the “process instance owner” (i.e., the person responsible for the process instance that is edited in contrast to the “process owner,” who is responsible for the process design of the generic process) and the right that enables the process structure to be adjusted is to be referred to as the “process instance owner” right. As will be appreciated by those skilled in the art, several users may have this right. The process structure, however, may not be modified concurrently by several users.

In one embodiment, a user may be assigned the process instance owner right via a process implementation system's rights management. This includes the right to change to the editing mode to “customizing.” The structure can only be modified via this mode. The user can only change to the customizing mode with this right. The logical, single-user mode is achieved via a specific locking logic for the customizing mode. Before the mode is changed, an attempt may be made to exclusively lock a specifically defined global object (e.g., data record or table). If this is not possible, this would indicate that another user is in this mode and changing to this mode is not possible. If successful, the lock is set until the user leaves the mode again, thus releasing the lock.

A series of editing steps can be carried out on a level superior to the process steps (structure elements). These operations may be activated by means of a context menu. The context menu is dynamically set up by a separate component (subject to the mode and properties of the selected process step). The object of the operations is in each case the process step that has the focus. Some operations also have effects on the inferior process steps belonging to the selected process step. For all operations that change the layout or structure of the navigator area 320, (e.g., renaming, deletion or adding process steps) the process instance owner right is required.

A process step may have two statuses: active or deactivate. In the original state of the database, all process steps are active. Active process steps are always displayed (for the user who has access rights to the process step). If a process step is deactivate, it is no longer visible in the tree. On the interface, the tree appears as if the process step had been deleted. Deactivation is therefore a function of customizing: it enables process steps that are not required to be removed from the process tree for a concrete process execution. The data structure of a deactivated process step still resides, however, in the database. Deactivated process steps may be reactivated.

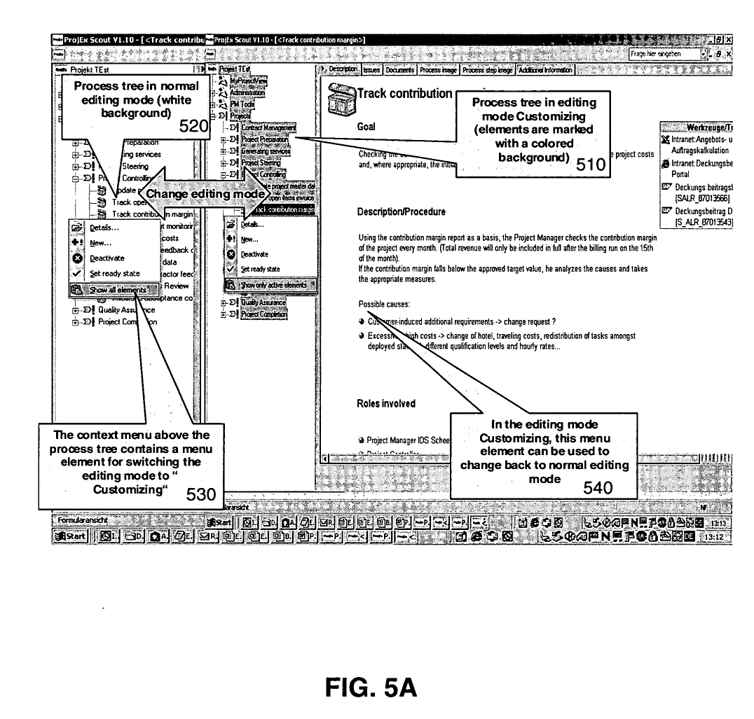

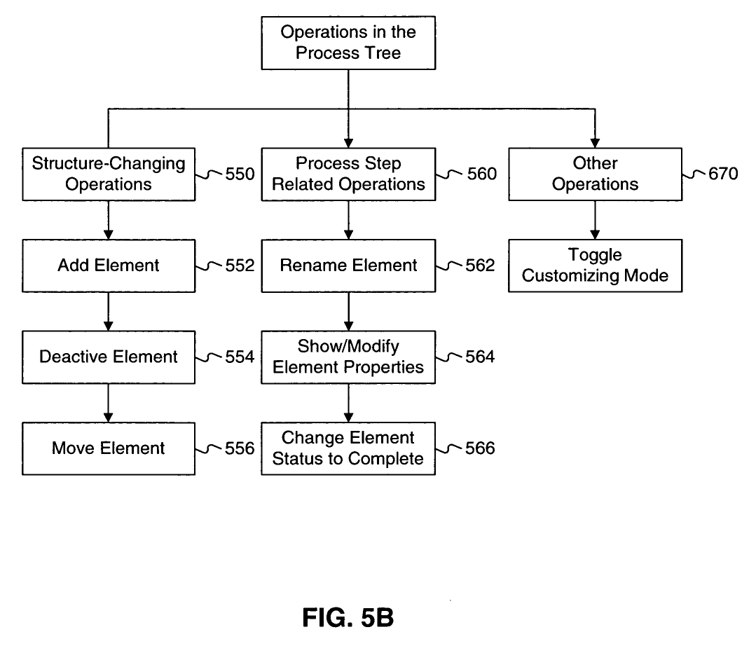

FIG. 5A is another exemplary GUI for a process implementation system, consistent with the present invention. The operations relating to the process structure may be carried out in two modes: a customizing mode 510 and a normal mode 520. The difference between the two modes is that in normal mode 520, only the active process elements are displayed, whereas in customizing mode 510 all process elements are displayed. Normal mode 520 shows the image of the adapted process, whereas customizing mode 510 additionally shows the process steps that were deactivated. The customizing mode 510 is therefore required in order to enable deactivated process steps (subject to the appropriate authorization of the user) to be reactivated.

The set editing mode is made visible by the use of an appropriate background color. Deactivated process steps are represented by different icons to active ones in the process tree. The editing mode can be switched via the context menu 530 of the process tree. The context menu 530 above the process tree contains a menu element for switching the editing mode to “customizing.” In the customizing mode 510, a menu element 540 may be used change back to the normal mode 520.

Operations in Process Tree

A series of editing steps can be carried out on a level superior to the process steps (structure elements). These operations may be activated via the context menu 530. The context menu 530 may be dynamically set-up by a component context menu factory.

The following may apply to the context menu 530: the context menu 530 that is currently active only contains operations that are relevant in the current context and that can be carried out by the user. This may depend on three things: the authorization assigned to the user who is logged in, the editing mode, and the properties of the element in focus (selected element).

In accordance with one embodiment, the context menu 530 may be set-up in accordance with the following algorithm or process when the function Open Context Menu, usually performed by a right mouse button, is activated:
1. Delete the existing context menu and create an empty context menu with the same name.
2. Determine the active editing mode.
3. From all the operations, select those that are active in the active editing mode.
4. From the remaining set of operations, select those for which the user has authorization (for example, if the user has not been assigned process instance owner right, all customizing operations are not available).
5. Determine the relevant properties (active, inactive, status, number of children, etc.) of the selected object.
6. From the set of operations remaining as a result of step 3, select the set of operations that make sense for the properties of the selected object.
7. Create a menu entry for each of the set of operations remaining after step 5 in a predefined order.
8. Link each menu entry with the associated operation handler.
9. Open the context menu.
10. Start the operation handler of the operation selected by the user.

The operations in the process tree can be divided into process structure related and process step related operations. As described above, structure-related operations are only possible in customizing mode. Element-related operations are also possible in normal mode. FIG. 5B provides an exemplary overview of the operations that may be available in the process tree. In general, these operations may include structure changing operations 550, process step related operations 560, and other operations 670. Examples of structure changing operations 550 include adding an element 552, de-activating an element 554, and moving an element 556. An “element” may be an activity or a process step that is part of a process. Process step related operations 560 may include renaming an element 562, showing/modifying element properties 564, and changing an element status to complete 566. Other operations 670 may include toggling the customizing mode 672.

Structure Modifying Operations

In accordance with embodiments of the invention, one or more categories of structure items may exist, as representatives of process steps. In one embodiment, four categories of structure items may be provided, including: generic items, original items, derived items, and links. Generic items may be items that are derived from the process model (process design phase) and, therefore, they cannot be generated by this function. Original items may bear all the necessary information such as names, linked functionality, dates, responsibilities, degree of completion, etc. Such items are not binding (for the purpose of the process design). Derived items may comprise items that are created from copies of structure items. All the useful attributes are copied and the ID of the source object is remembered. The derived item can be compared with the original item. Derived items do not have the status and date information of the original item. Derivatives can be formed from all items, not just from the links.

A structured item may also be a link at any position. Links can be inserted at any position. In one embodiment, links are assigned a unique icon that indicates that they are links. Links can be deleted, renamed or moved as required. By way of example, links may be created by pressing CTRL+C to copy the object to be linked and then pressing CTRL+V to insert it at any position in the tree. If a link is selected in the navigator area 320, the selection may be automatically “reassigned” to the original item (i.e., the structure item in the tree to which the link refers is selected). Automatic expansion and scrolling may be possible in the order that the original item is visible. A link cannot be created from links. If the linked item is deleted, all its links are also deleted (and not merely set to inactive).

In accordance with another aspect of the invention, adding a process step may be done in one or more different ways, for example: by generating a completely new structure item (original structure item), by copying an existing structure item (derived structure item), and/or by generating a link to a structure item (link). The manner in which the operation is activated by the user may depend on the type of structure item to be generated.

Original structure items may be completely redefined, as initially, no information is available. For example, the user selects the structure item that is to be superior to the structure item to be generated (its father) and activates the function “Generate Structure Item” in the context menu 530 (cf. FIG. 5A). A new data record is then generated for the structure item and planning element, which is automatically assigned to the structure item, which is then immediately displayed in a modal dialog for entering the other properties of the item. The dialog shows the data contents of the structure item as it was initially set by activation of the function. The other data fields must be maintained by the user. When the dialog is closed, the process tree is updated and the new structure item is visible.

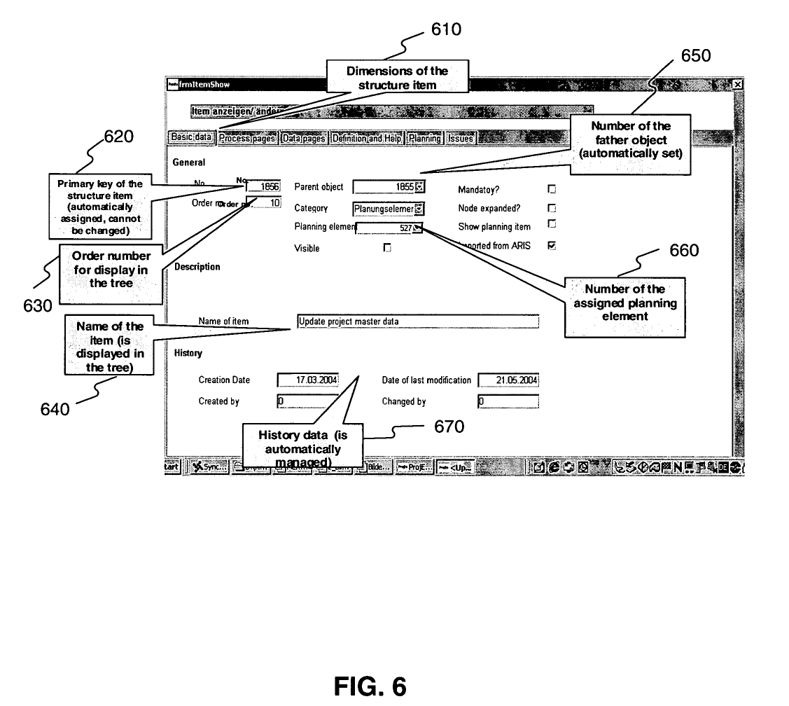

FIG. 6 is an exemplary GUI for entering the data of the generated structure item. The dimensions of the structure item may be located under a “Basic Data” tab 610. The primary key of a structure item 620 may be automatically assigned and not changed. The dimensions may also show an order number 630 for the display in the tree. The number of a father object 640 of the structure item may be automatically set. The dimensions may also show the number of a father object 650, and the number of an assigned planning element 660. History data 670 may also be shown under basic data.

Existing structure items may be copied in one or more ways, for example: copying an individual item or copying a section of a tree (of an item with all its inferior items). Copying a section of a tree enables not just individual items to be copied, but also entire structures.

In one embodiment, copying an item comprises two components: creating a new data structure and partial transfer of data contents (properties) of the old element to the new one (e.g., description page, tools, etc.), and creating a relationship between the copied and the new data structure. The new element may “remember” the key of the element whose copy it is, with the new element regarded as being “derived” from the old element.

During the copying process, the relationships which were assigned to the original element during editing may not be transferred. For example, the assigned templates are transferred, but not the documents that belong to the original. Further, although a planning element is generated, the planning data is not transferred, instead, this data is set to initial values.

The possibility of deriving one process step from another also enables the process step with all its derivatives to be categorized. For example, if the step “Perform Test” is derived, a user can easily search for all the derivatives of this step, and a user can “compress” them by the attributes of this step. For instance, a user may inquire about how much time was required for all tests together etc.

If entire structures are copied, this may be treated as equivalent to copying individual elements. However, many items, together with their structure relationship, can be derived with a single user action. For example, if the originals X and Y are in a relationship of Father'Child, this may also apply to their derived elements X′ and Y′.

In one embodiment, an individual element can be copied in one or more of the following ways:
1. Selection of an element, copy via the menu function (Copy Element), selection of the new father object (destination) and insertion via the menu function (Paste Element).
2. Selection of an element, activation of the accelerator keys CTRL+C, selection of the new father object (destination) and insertion with CTRL+V.
3. Selection of an element, dragging the element (press the mouse button) while keeping the Shift key pressed to the new father object (destination) and activating drop mode (release the mouse button).

All the various copying methods may lead to the same result. In addition to the generation of a derived structure item in the database, the element is also inserted at the relevant position in the navigator area 320. If it is inserted under a father who already has children, it is automatically moved to the last element and the user can then move it to the correct position.

Copying of structures can only be carried out via the context menu 530 (e.g., copy and paste via the context menu). This functionality is only visible in the context menu 530 if an element in the process tree with active children has been selected. Before the structure is generated, the user is asked again if he or she really wants to do this. If a structure is copied, only the active elements of this structure are copied and the inactive elements are not found in the new structure.

Consistent with the present invention, links are elements of the structure tree which refer to others. Besides the information regarding where they are located in the structure tree (i.e., the number of the father element and the order number), there exist only a type description and the key of the element to which the links refer. Links may be generated in the same way as derivatives (e.g., copy and paste via the context menu). The links do not, however, have their own planning elements.

Deleting and deactivating structure items are also possible. By way of example, non-deletable structure items may include:
Mandatory objects: Objects that were marked as mandatory in the process design.
Structure items with children: If a structure item has children, they must be deleted first, before the structure itself can be deleted. This prevents mandatory objects or entire subtrees from being deleted inadvertently (or elements “will be orphaned”).
Structure items for which completion progress has already been reported.
The top structure element.

In one embodiment, to delete an item, the user selects it and activates the operation. The function can only be activated if the selected structure item can be deleted. Immediately after deletion, the tree is reloaded and the result of deletion becomes visible. Deletion only involves deactivation of the node, except for the items that are actually deleted. The node, therefore, actually still resides in the database. As disclosed herein, deactivated structure items can be reactivated via the customizing mode.

Deactivated process steps can only occur in customizing mode 510 (see FIG. 5A). With deactivated process steps, the operation “Reactivate Process Step” is found in the context menu. If this operation is activated, the status of the structure element is set to “active” and the process tree is reloaded. The new status can, therefore, immediately be seen in the navigator. After reactivation, the structure element carries all the information it had at the time of deactivation (e.g., assigned documents, tools, etc.).

A user of the process implementation system 200 may also rearrange the process tree. For example, the elements could be placed in a different order or could be moved under other nodes or “fathers.” This may be required if, for example, the process step(s) is/are to be carried out in a different process phase.

In accordance with an embodiment of the invention, the user has two possible ways of activating this operation:
1. An element can be moved using a drag and drop operation, by first selecting it, then switching to drag mode and then dragging and dropping it in the new position.
2. An element is moved using a cut and paste operation. These functions are then activated via the context menu.

If an element is dragged to or inserted in a new location, these operations may result in the removal of the element to be moved from its original position in the tree and its insertion in the position that was selected as the destination. This has the effect that the destination element and all the following elements are moved one position back. One particular problem in this case is that elements can be in both a horizontal relationship (in a sequence of the elements of the same level) and a vertical relationship (subordination relationship). The destination objects can therefore constitute both the position in front of which an element is to be moved, as well as the father under which an element is to be moved. To distinguish between these two options, the system may analyze whether a predefined key (e.g., the CTRL key) was activated during the drop operation. If so, the element is placed under the destination, otherwise it is placed in front of it.

In one embodiment, at the beginning of the drag operation or when the “Cut” operation is activated, the object to be moved is determined first. With the drop or paste operation, the destination element is determined. Moving an element may comprise the following operations:
determination of the new father object (which may also be the old one) and replacement of the father key in the data structure;
determination of the new location under the siblings and resetting the new order in the data structure; and
representation of the change to the interface.

The first operation can be carried out by replacing the key of the father object in the data structure of the object to be moved by the key of the father of the destination object or, if inserted using CTRL, of the new destination object. The element is therefore vertically reassigned.

The arrangement of the elements under the children is enabled by sorting on the basis of a data field of the structure item, the order number. Initially, the order number is predefined by the import of the process structure from the process design. It is a numerical value (e.g., initially in steps of 10), the elements are sorted in ascending order. The task is now to move the selected element between the destination element and its predecessor, i.e., to assign an order number to it that is lower than the destination element and higher than its predecessor.

A distinction may be made between the three following cases:
The numerical distance between the predecessor element (if the destination element is the first element, the predecessor element has the order number 0) is >1: The element can then be simply inserted by setting the order number to the integral value of the difference of (destination−successor)/2 (to facilitate further insert operations the distance is halved).
The numerical distance is =1: the element to be moved then receives the order number of the destination. The distance between the destination and the successor element is then determined. If there is no successor element, the order number of the destination is simply incremented by 10. If there is a successor element and the distance of the order number is >1, then half the distance between the destination and the successor is simply added again to the order number of the destination. If the distance is only 1, the destination is assigned the order number of the successor and the operation described is repeated for the successor. This is continued until there are no more successors or until the distance of the order numbers is >1.
The destination is an element that does not have any children yet: In this case, the order number is initially set to 10.

Due to the potentially cascading reordering of the order numbers, the tree may be reconstructed after this operation in order to represent the new order in an adequate manner.

Element Related Operations

Consistent with the present invention, element related operations can be regarded as a special case of modifying process step properties. By way of example, it can be directly overwritten by clicking on the process step in customizing mode (“direct titling”).

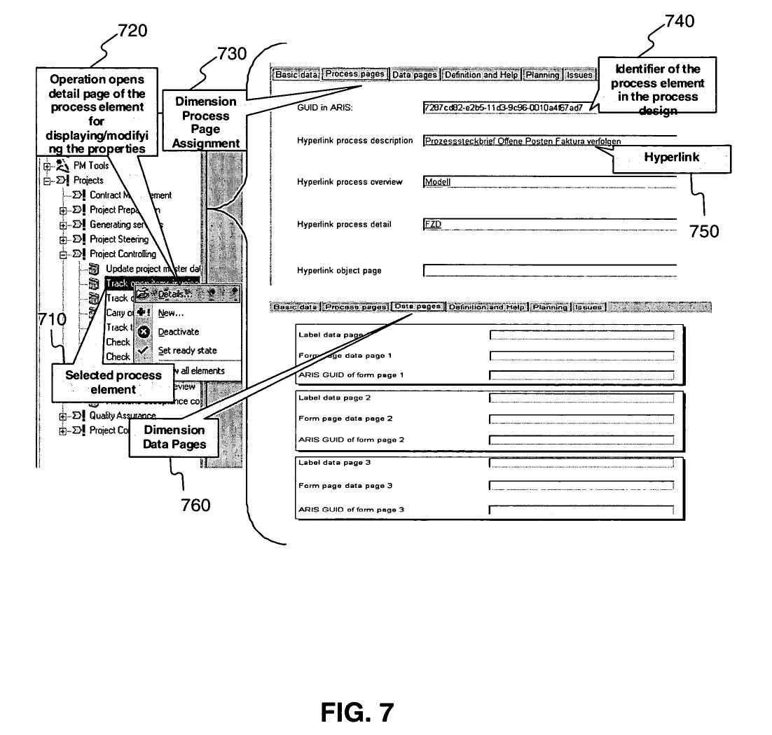

FIG. 7 is an exemplary GUI showing how to modify process step properties, consistent with an embodiment of the present invention. As shown in FIG. 7, changes to the process step properties can be made by activating the detail page of the structure item if the appropriate authorization has been granted. For a selected process element 710, a detail page of the process element is opened for displaying/modifying properties 720. Based on that selection, a dimension process page assignment is shown 730. In the process pages, an identifier of the process element is shown 740, as well as a hyperlink 750 for the process description and the dimension data pages 760.

The properties may be modified via the same dialog with which new process steps can be maintained. As the modification of the properties may have an influence on the representation of the structure item in the navigator, the process tree is reassembled if relevant data was modified.

If a process step (or work package) is executed, this can be reported back via the action dimension planning of the structure item. Differentiated data such as actual expenditure can then be maintained.

In one exemplary implementation, if an item that has not yet been reported as done is selected, the context menu returns an entry in the context menu 530 with which this functionality can be activated. The menu entry is missing for process steps already reported as done. If the user activates this entry, the status of the assigned planning item is set to “done” and the completion progress is set to 100%.

In addition, a note of which user set the status on which date is made in the history. The update of the planning element remains hidden from the user. The navigator asks the icon dispatcher for the relevant icon for the new properties of the element and replaces it so that the completion is directly visible in the tree for the user. The process tree does not need to be reassembled as the completion report does not have any influence on the structure.

Action Framework (Detailed Area)

If a structure element is selected in the navigation framework 310, the action framework (detailed area 320) provides all the information and possible actions (action dimensions) that are meaningful for this structure element.

In one embodiment, the following requirements are met:
A complete overview of all the action dimensions are available.
If a dimension is selected, the user interface makes this possible action available in a user-friendly manner (i.e., a reasonable size of the area of the user interfaces with all the displays and control options that are required for complete processing).
The user is able to recognize at any time which dimension is selected.
It is very easy to toggle between dimensions.
If actions within a dimension refer to a number of possible objects for this action, this 3^{rd} stage of the selection is represented in a uniform manner in the action dimension in question.

The principle of focus constancy should be implemented in such a way that the dimension only changes if this was explicitly initiated by the user. This also applies if the user selects a different structure element.

In contrast to the structure elements, there is usually no relation between the different dimensions. For example, a dimension is not inferior to another dimension in the same way as a process element can be inferior to another process element. They also do not necessarily have to follow each other.

As part of the action dimensions are standard views of the process element (e.g., description or documents, etc.) and the number of possible dimensions is usually very restricted (e.g., approximately 5-12). These dimensions can be represented in the form of multiple pages (e.g., the data processing equivalent of the index card, with the dimensions acting as the “tabs”, that are also always visible). In this concept, an action dimensions is represented by a page. The action dimension is activated by selecting the corresponding dimension, which means that the form which represents the action dimension is brought to the foreground and optically overlays all the other forms. This ensures that the user is provided with the maximum detailed framework.

At the same time, however, all the other “tabs” that represent the other action dimensions are still visible in the dimension selection bar. To change a dimension, the user may simply click on the required dimension. This design offers a maximum effective area for the action dimension forms, as well as a complete overview and the possibility of changing quickly between the dimensions.

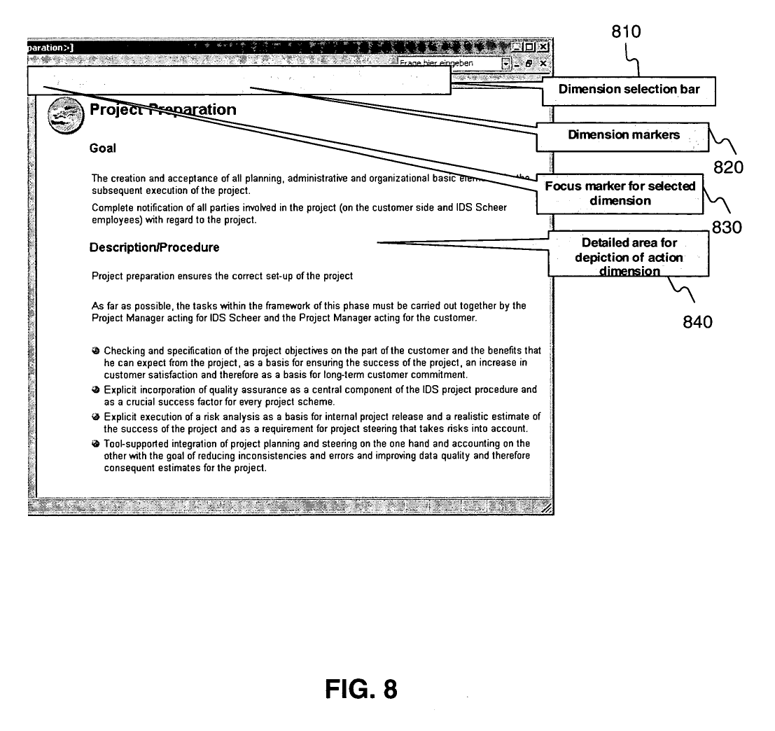

FIG. 8 is an exemplary GUI showing the structure of the detailed area, consistent with an embodiment of the present invention. A dimension selection bar 810 is header area of the action page. This bar contains all the actions relevant to the active structure element (possible actions). In the example of FIG. 8, these actions include the description page (displayed), the planning page (hidden), the issue page (hidden), the documents page (hidden), and additional information page (hidden). The bar dynamically adapts to the dimensions of the selected structure element.

A dimension identifier 820 is a short and concise name for the dimension. The principle applies that dimensions with the same semantics always have the same name. As an alternative to the form of representation implemented, the dimension identifier can also be implemented with a preceding icon, which is also an optical representation of the action dimension.

At the same time, the dimension marker 820 may also be used as a “switch” to change to a different dimension. To change to the new dimension, the user simply clicks on the area in which the dimension identifier is located: The new dimension page is then brought to the foreground, therefore overlaying the old page.

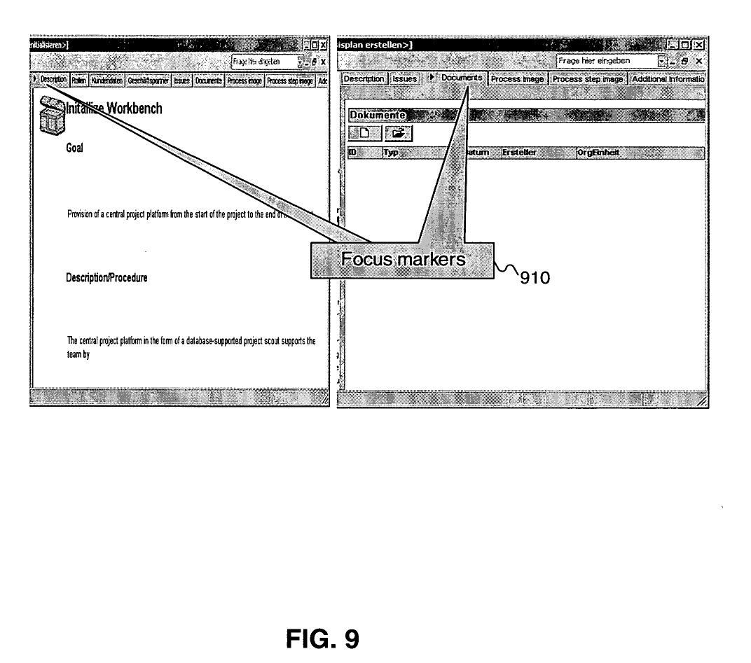

A focus marker 830 displays which dimension has the focus, i.e., is on top. In this example, this was implemented by an additional icon in front of the dimension identifier. Another possibility would be to change the font or type size to indicate the selected dimension. When a dimension is changed, the focus marker is set in front of the identifier of the selected dimension and the identifier of the previously selected dimension is removed. The focus marker may mark the dimension that is currently active. In one embodiment, the description is provided on the left, and on the right are the documents. An example of this is illustrated in FIG. 9, which includes a focus marker 910.

Referring again to FIG. 8, a detailed area 840 is the actual contents area for the action dimension. The design of the detailed area depends on the type of action dimension.

In accordance with one embodiment, the order of the action dimensions is constant. However, the number of dimensions is not constant, (every dimension may be hidden) the dimension identifier can “wander” when the structure element is changed. If, for example, a structure element A has the dimensions X, Y, Z and the next selected structure element B has the dimensions X, Z, the dimension marker Z “wanders” to the right when the user changes from structure element A to B.

There may be a predetermined default order of dimensions, which is based upon the assumed degree of frequency of use. The dimension bar may represent the dimensions from left to right in order of decreasing importance. The default order can be changed by the user via a configuration dialog. The changed setting remains active until the user decides on a different setting. In some cases, it may be useful to completely hide dimensions. For example, no issues could be used in a particular application. In this case, there may be two ways of hiding dimensions. First, the dimension can be globally hidden by a user with administration rights. In this case, the dimension is no longer visible for all users (also no longer appears in the configuration dialog for user-specific settings). From the dimensions permitted by the administrator, the user can in turn hide the dimensions that are not of any interest to him (e.g., as an experienced user he could hide the representation of the process images). This can be set by the user-specific configuration dialog and remains active until the user changes the configuration.

Action Dimensions

Consistent with the present invention, each interaction with a structure element is embedded in an action dimension in which this interaction takes place. The type of interaction is dependent to a large extent on the meaning of the structure item which is currently in focus. However, the dimension may be categorized with regard to type and structure and to show as an example some characteristics of visualization. In accordance with one embodiment, the three types of dimensions are: process design drive, standard functional cover, and specific functional cover.

(i) Process Driven Action Dimensions

A common characteristic of all action dimensions is that they may provide information arising from the process design. These dimensions together form the process documentation and work instruction for a particular process step. They have a primarily passive character and cannot be changed (i.e., they are supposed to represent the flow in its normative character). Nevertheless, they can be linked to elements of the functional cover or other tools wherever it makes sense.

Each process element may comprise the following document properties:
It is part of a flow which shows the entire correlation of the process and in particular predecessor and successor functions. A useful representation of this correlation is a process image (e.g., in the form of a flow diagram of an eEPK, etc.) [process image].
It has a working environment which includes the roles, tools and documents involved and, if appropriate, other information. A useful representation of this is a graphical representation of the work step with a schematic representation of tools, people responsible, etc. [process step image].
There is a textual description which describes in words the task to be performed on this process element (“work instruction”). A suitable form of representation of this could be, for example, an HTML text page [process step description].

By way of example, subtypes of process-driven action dimensions are process image, process step image, and process step description.

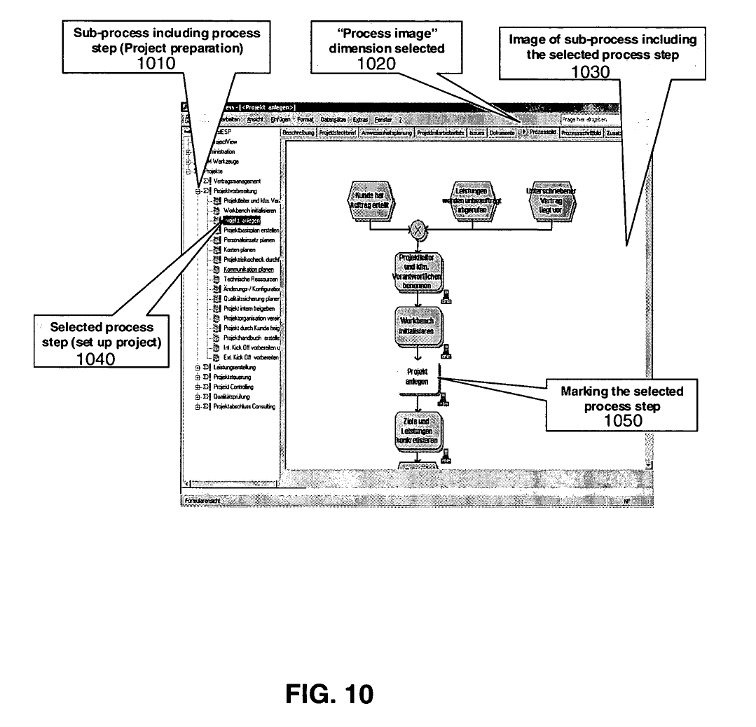

FIG. 10 is an exemplary GUI of a process image, consistent with the present invention. In one embodiment, the dimension process image comprises a Microsoft Web browser control. If this dimension is activated, an HTML page containing the image of the process (a GIF file in the implementation) is loaded. This may be achieved using the navigation area 310. The HTML page and the GIF file may be generated by process export. The name of the HTML page is assigned as a special data field to the structure element of the navigator. The actual address is made up of the hyperlink base, the directory in which the HTML pages to be displayed were installed, and the name of the file.

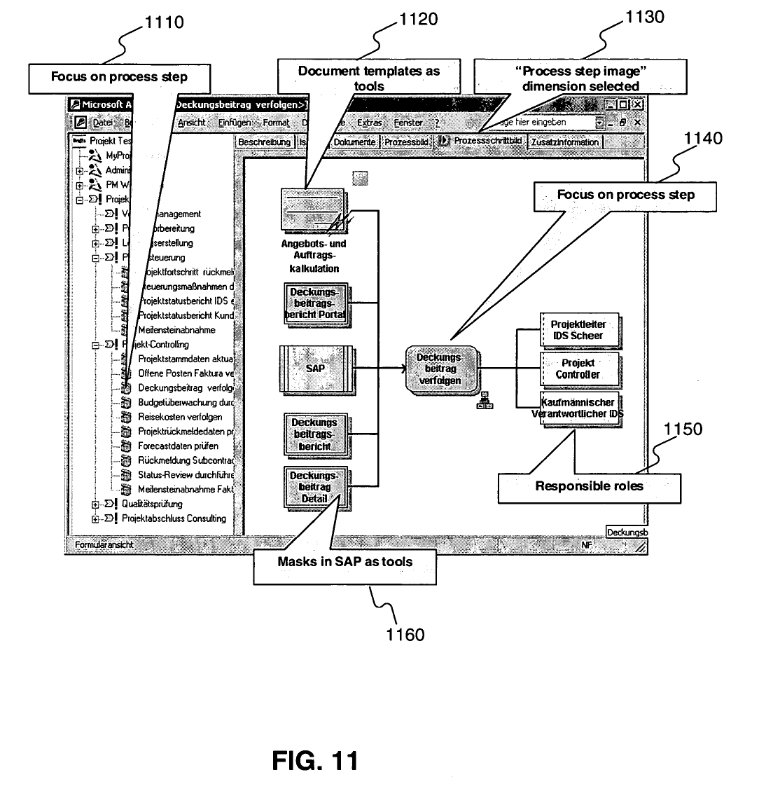

FIG. 11 is an exemplary GUI of a process image step, consistent with the present invention. In the example, a process step image 1130 is a graphical representation of the standardized detail information about process step 1110 and 1140. This provides the user with a quick reference to the essential information that is required for carrying out the process step. The dimension process step image may also comprise a Microsoft Web browser Control. If this dimension is activated, an HTML page containing the image of the process (a GIF file in the implementation) is loaded (e.g., using the navigation area). The HTML page and the GIF file were generated by process export. The name of the HTML page is assigned as a special data field to the structure element of the navigator. The actual address is made up of the hyperlink base, directory in which the HTML pages to be displayed were installed, and the name of the file. The document template as tools 1120 and responsible roles 1150 may also be shown.

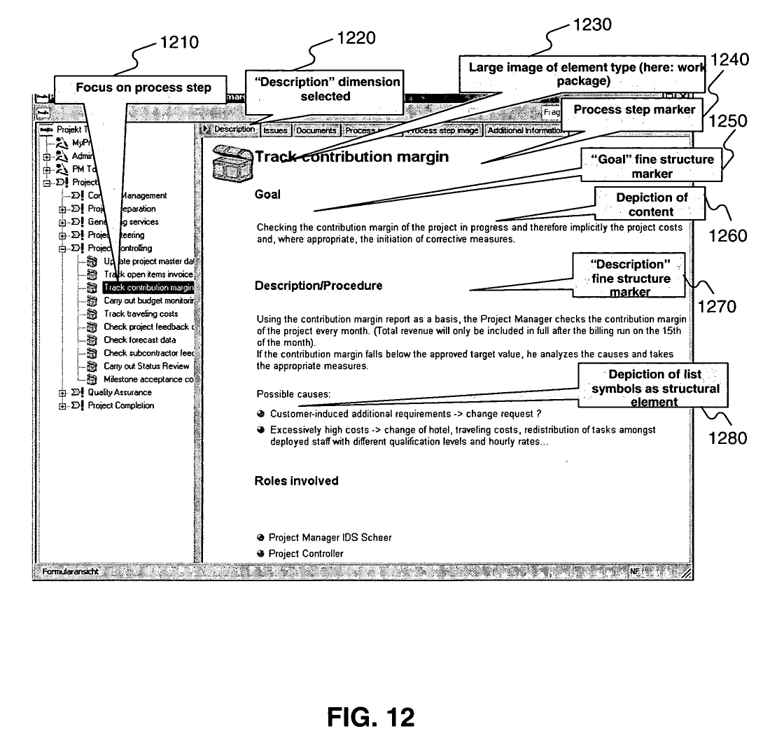

FIG. 12 is a exemplary GUI of a process step description, consistent with the present invention. In contrast with the two other dimensions, this is a textual description of the process step. This textual description is static. The textual description is intended to convey an understanding of the work step which goes beyond the purely graphical representation. It is, therefore, advisable to structure the information in a useful manner (fine structure).

For example, you can select, via a work instruction, a regular mode of representation which is divided into, for example, the sections: Goal, Description/Procedure, Roles Involved, and Tools. Completely different structures and/or combinations thereof are also possible.

From an optical perspective, the page layout has a uniform structure. At the top of the page under a “description” dimension 1220, there is a magnified image of an icon 1230, which represents a process step 1210 in the navigator (a reference to the type of structure element). The name of the process step is selected as a heading 1240. The fine structure is then made up of the identifier of the fine structure element (e.g., “Goal”) 1250 and the associated text 1260. Bullets are used as graphical representations of list symbols. All information that is displayed in this page is already maintained within the framework of the process definition. They may be stored in a database as attributes of the object which represents the process element. A description fine structure marker 270 and the depiction of list symbols as structured elements 1280 may also be shown.

In one embodiment, an application or software tool generates the HTML page in accordance with the attributes of the object. As in the case of graphical process information, the HTML page is loaded in a Microsoft Web browser. The name of the page is also saved in a data field of the structure element. The actual address is formed in the same way as with the graphical process pages.

(ii) Standard Functional Covers

The term standard functional covers refers to all dimensions which as a rule, irrespective of the meaning of the process step, always relate to a process element. This functional cover transforms an information object, which is represented by the process step at the design level, into an action object, which can be specified, amended and extended for each specific process.

If the user interface is used for other purposes, the concept of the standard functional cover is useful, but may be replaced by different standard functionality; in this regard, an exception may be made for the dimension “Additional Information”. Types of standard functional covers include: Planning, Activities, Documents and Additional Information.

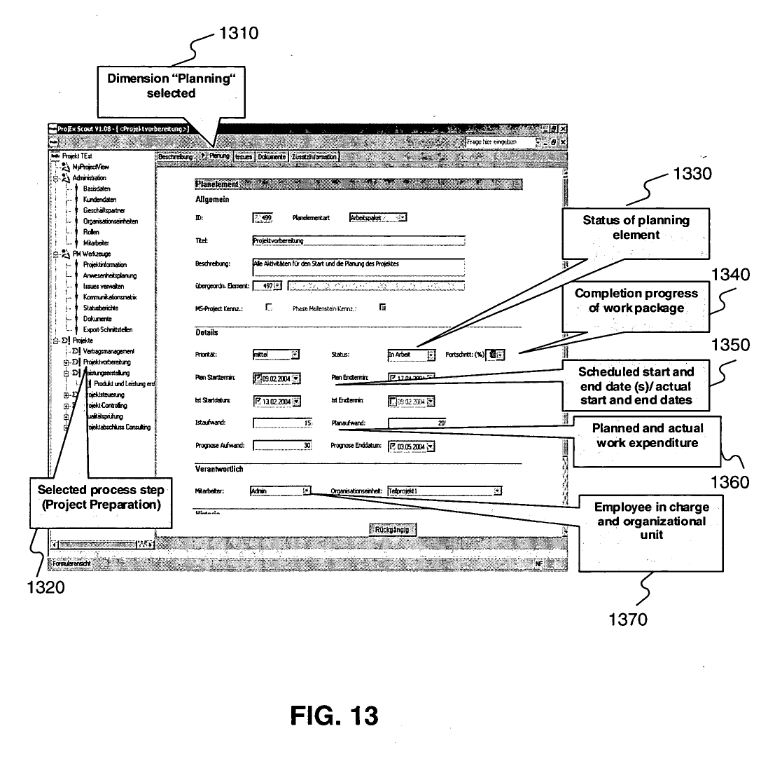

There is an action dimension “Planning” for all process elements. FIG. 13 is an exemplary GUI of Standard functional cover “Planning” with the data fields for planning and feedback of the completion progress of the process element. When an element of this type is selected, a dimension “Planning” 1310 appears in the dimension bar. If this dimension is selected, the planning dialog for this process element is brought to the foreground. This enables specific planning information for this process step to be displayed and entered (e.g., start and end date, expenditure, responsibilities, etc.).

Various aspects of “Planning” may be shown. For example, the status of a planning element 1330, completion progress of work package 1340, scheduled start and end dates 1350, planned and actual work expenditure 1360, and an employee in charge/organizational unit 1370.

The planning element (as a collection of the data fields used for planning and feedback of the degree of completion of the process element) forms a separate data structure that, in addition to the structure element, is generated whenever a new structure element is created. Planning elements are also in a hierarchical relationship with each other.

During the design phase, it is defined whether a planning element is to be displayed for a process element. If so, the action dimension “Planning” automatically appears in the dimension bar. The property “is a planning element” is a Boolean attribute of the structure element. There is a foreign-key relationship between the planning element and structure element (the planning element “remembers” the structure element to which it belongs and vice versa.

The form in which the fields are embedded is designed as an independent “Access” subform. The data page that forms the foreground when the dimension “Planning” is selected only contains a control for embedding the subform. When the dimension is activated, the subform with all the data elements is automatically loaded.

There is also a dimension for all process elements for managing activities belonging to the process element. There may be a 1 :n relationship between the process element and activity, i.e., a list of activities can be assigned to each process element. This list may also be empty.

In one embodiment, activities are managed as separate data structures. For example, there is a separate data element for each activity, which contains data fields for describing, planning, status and responsibilities with regard to the activity. The activity has a direct reference to the structure element which it belongs to.

The action dimension “Activities” is represented on the user interface by a list of activities that exist for a process element. New activities may be created and planned. The activity in focus is displayed in each case in a detailed area.

Documents that are the result of a process step belong to this process step. Any number of document templates can be assigned to each process step. A distinction may be made between general templates which are available at every process step (e.g., presentation templates, technical concept templates, protocol templates) and process-specific templates that are suitable for specific tasks (e.g., order calculation template, project plan template, change request template, etc.).

The assignment between the process step and process-specific templates is already made at the process design stage. This information is taken from the process model and linked to the structure element.

The action dimension “Documents” therefore first shows the templates belonging to this process step. If documents were created from these templates, these documents, together with meta information about this document (e.g., author, time of creation, comment, release status, etc.) may be displayed in the form of a list in the action dimension form. The document is opened and can be viewed or edited (if the appropriate rights have been assigned to the user) by selecting an element from the list.

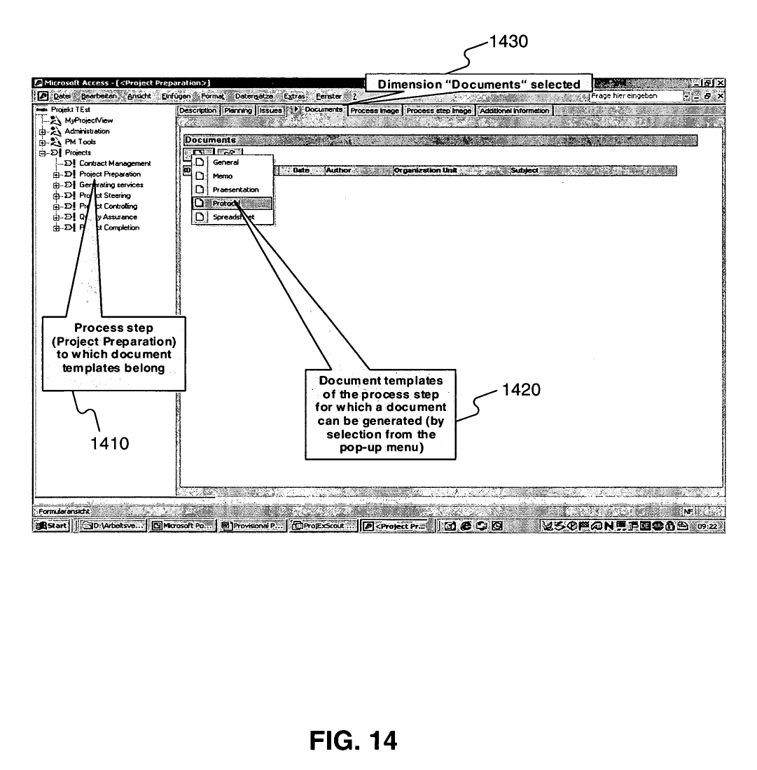

FIG. 14 is a GUI of Work dimensions “Documents” with an empty list of documents and the selection of assigned document templates, consistent with the present invention. As shown in the example of FIG. 14, a process step 1410 is first selected and the dimension “Documents” 1430 is selected. As a result, documentation templates of the selected process step for which a document can be generated may be presented to the user 1420.

The assignment of templates to process steps may be defined in the process design phase. In one embodiment, these assignments may be imported using an application, such as the Scout application available from IDS Scheer (Saarbruecken, Germany). In another embodiment, an importing engine such as that described in the above-referenced, co-pending U.S. patent application entitled “Systems and Methods for Integrating Business Process Documentation with Work Environments” (Attorney Docket No. 09268.0004-00) may be used.

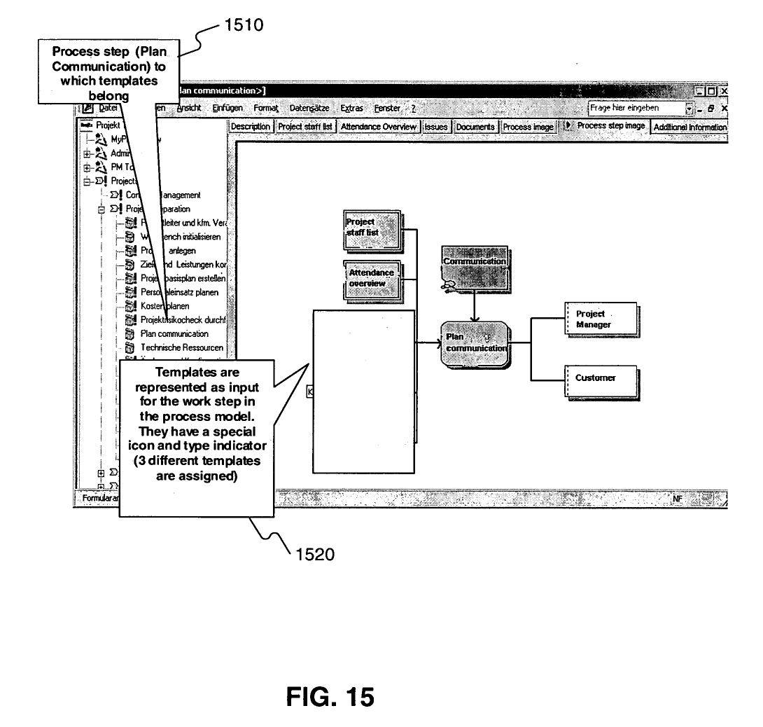

In accordance with one embodiment, the following information may be required at the design stage, as represented in the exemplary embodiment of FIG. 15:
The object is of the type “template” 1520
The template is the input for the process step it is assigned to
The name of the template
The source path of the template
The identifier of the process step which the template belongs to 1510

In addition, a predetermined set of superior templates may be defined, which is provided at every process step.

The project manager (e.g., an application administrator or other authorized user) can change the assignment of templates and process steps via a configuration form. For example, the project manager may assign additional or different templates or remove assignments.

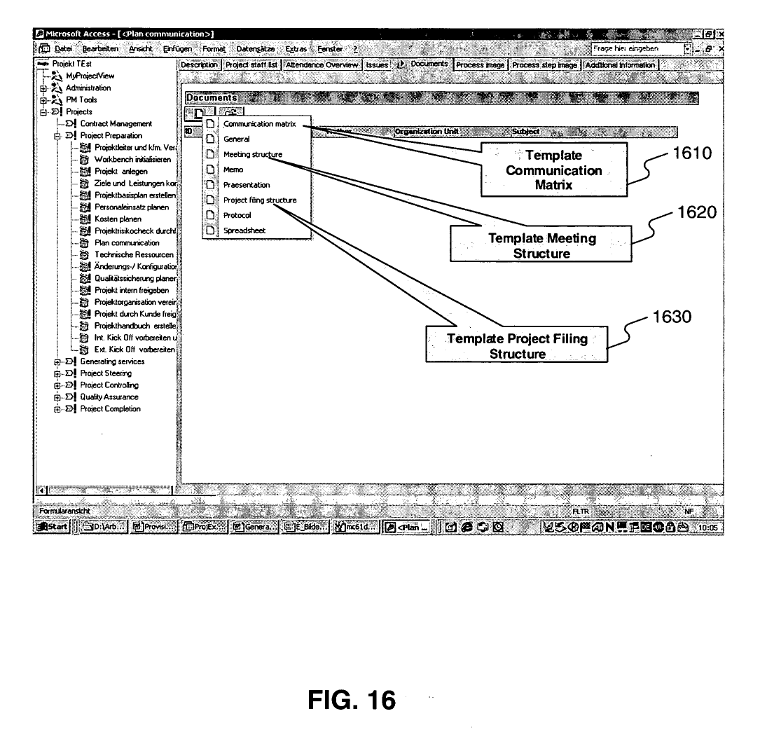

FIG. 16 is an exemplary GUI of a process design and list of templates for this process step, consistent with the present invention. As shown in FIG. 16, a template list may include a list of available templates, such as a template communication matrix 1610, a template meeting structure 1620, and a template project filing structure 1630. In addition to the three process-specific templates, default templates may also be available. The additional information provides a data field in which the project manager (e.g., an administrator or other authorized user) can supplement information about the process step. This information supplements the general information relating to the process design for the employee or other user.

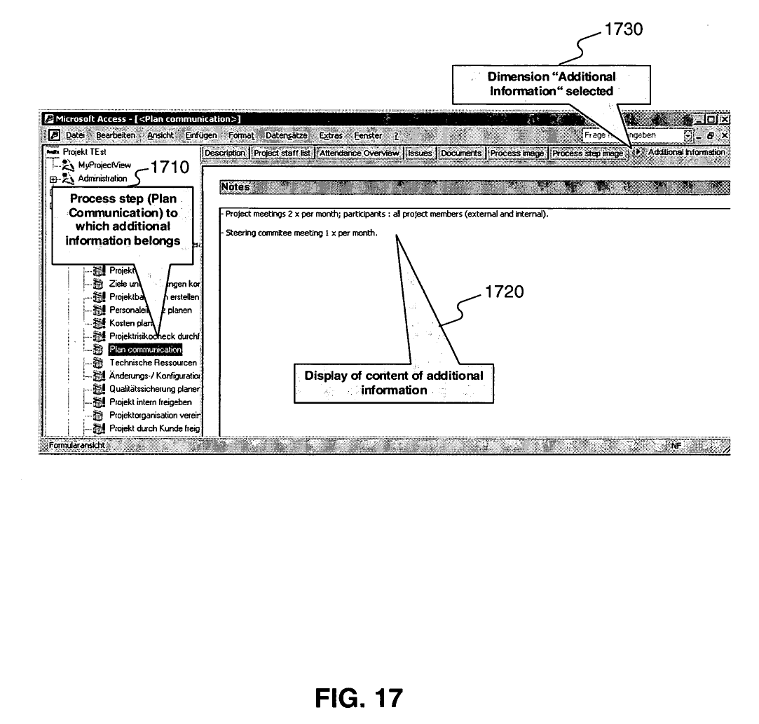

FIG. 17 is an exemplary GUI of a dimension “Additional Information,” consistent with the present invention. As shown in the example of FIG. 17, first a process step 1710 is selected. A dimension “Additional Information” 1730 is then selected and the display of the content of additional information 1720 is shown.

(iii) Specific Functional Cover

The term “specific functional cover” refers to all dimensions which provide process-specific functions or possible actions. Process-specific functions are dependent on the semantics of the process step and may only be related to this process step or a very small subset of all process steps. It is not out of the question that also elements of the specific functional cover can be used for more than one process step.

The specific functional cover may be empty or may comprise any number of action dimensions. The elements of the specific functional cover should be defined at the process design stage. These elements represent functional modules which have their own user interface (form) and an appropriate data structure, which is part of the application system's database in the reference implementation, but could also be embedded in other systems. These elements may be represented by a special symbol and a type, in order that they can be recognized as elements of an importer, such as the importer engine described in the above-referenced, co-pending application (Attorney Docket No. 09268.0004-00) or a similar importer.

Consistent with one embodiment, on import, the following data is imported from the process design and linked to the process element:
Identifying key of the process element to which the specific functional cover belongs.
Name of the element which is to be displayed as an action dimension.
Internal name of the form that constitutes the user interface for the functional element.

In contrast to the standard functional cover, both the number and name of the specific action dimensions are dynamic and are therefore modified when the process step changes. The following two examples illustrate the adaptation of the dimension bar subject to the specific functional cover of the process step.

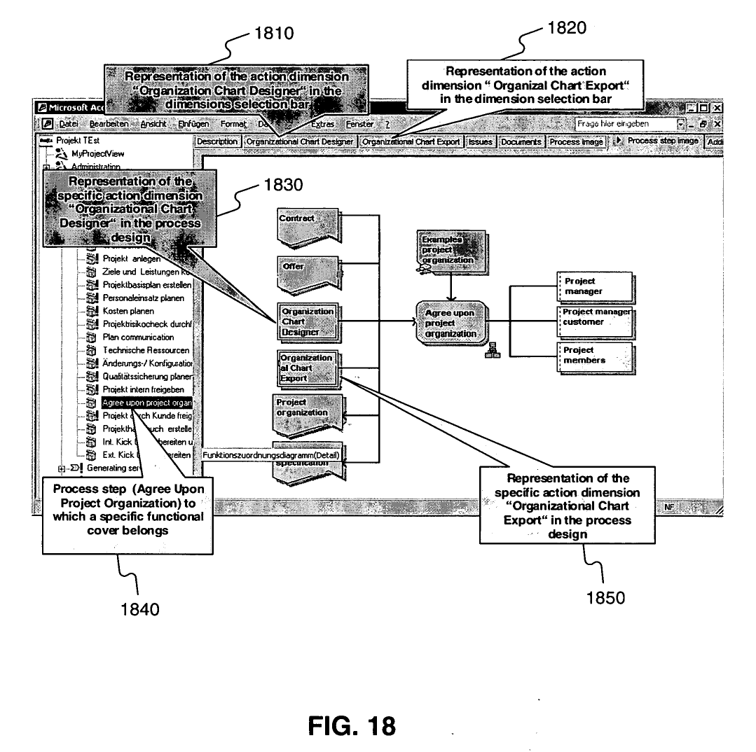

FIG. 18 is an example of a process step with a specific functional cover with two elements, consistent with the present invention. A process step (in this case “Agree upon project organization”) to which a specific functional cover belongs is first selected 1840. Then, the representation of an action dimension “Organization Chart Designer” 1810 in the dimensions selection bar may be shown. The representation of an action dimension “Organizational Chart Export” 1820 in the dimension selection bar may also be shown. Further, as shown in FIG. 18, representations of specific action dimensions “Organization Chart Designer” 1830 and “Organizational Chart Export” 1850 can be shown in the process design.

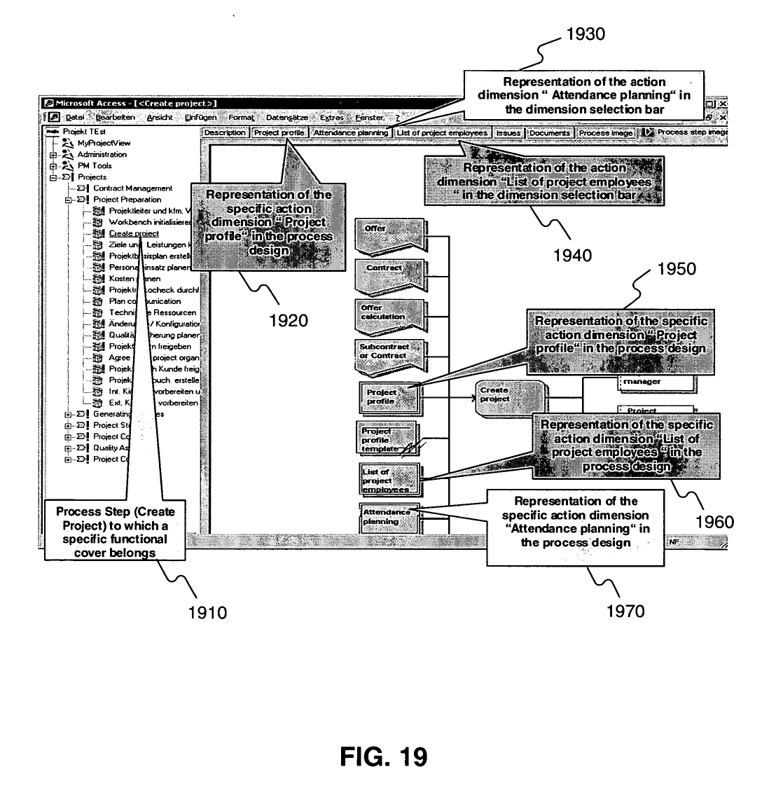

FIG. 19 is another example of a process step with a specific functional cover with three elements, consistent with the present invention. A process step (“Create Project”) may be selected first 1910. In response, the representation of a specific action dimension “Project Profile” in the dimension selection bar and process design may be shown (see 1920 and 1950, respectively). Further, the representation of an action dimension “List of Project Employees” may be provided in the dimension selection bar and process design (1940 and 1960, respectively). Moreover, the representation of another action dimension “Attendance Planning” may be provided in the dimension selection bar and process design (1930 and 1970, respectively).

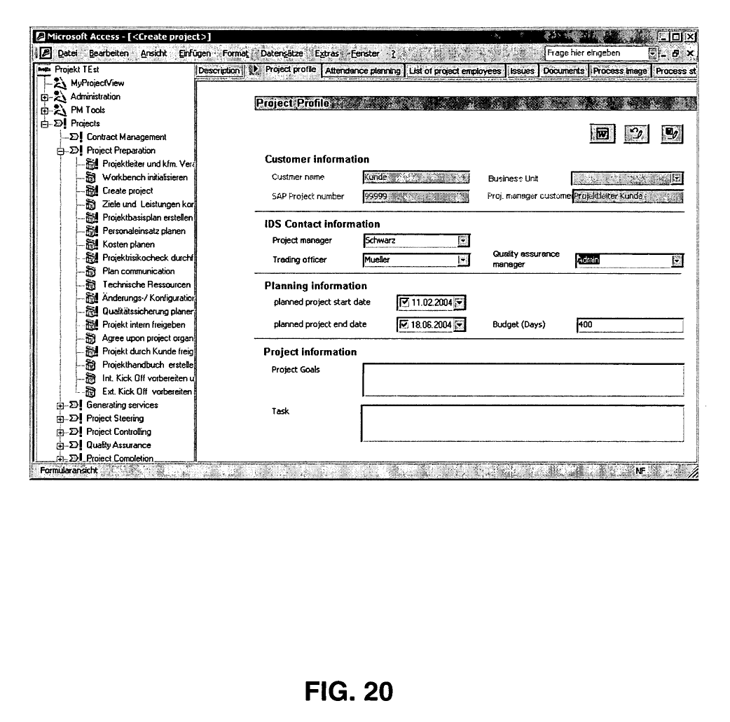

FIG. 20 is an exemplary GUI of an action dimension “Project Profile,” consistent with the present invention. By analogy with templates, there may be an m:n relationship between process steps and elements of a specific process cover. There is a data structure for elements of the specific process cover. If an element of the specific process cover is used several times, the same representation element is assigned, already during the design phase, to all process steps that use this form. The representation element may include the following attributes:
Unique key (GUID).
Name with which the element is to appear in the dimension bar (depending on the interface language).
Internal name of the form to be loaded.
Type marker for elements of the specific functional cover.

On import, a data element is generated for the form, which contains the name, GUID (for unique identification) and the name of the form to be loaded as data fields. A corresponding entry, in which the process step and form element are brought into relation, is generated in the assignment table for each process step to which this form is assigned.

Dimensions in the multipage control are already preconfigured for accommodating specific functional covers (e.g., a maximum of 16). These dimension pages and not visible by default and contain an empty subform control. If the process step is selected by the user, all the associated form elements are loaded via the structure element which represents the process step. By way of example, for each form element:
A data page is made visible.
The identifier of the data page is set to the name defined by the process design.
The form name also defined in the process design is set as the data source for the subform control.

If the user activates the corresponding action dimension, the form is loaded in the subform control and brought to the foreground.

Selection of Action Objects

Some action dimensions may allow operations via a list of objects (e.g., list of documents, tools, etc.). The action dimension can represent this list of objects in an appropriate manner and enable the user to select the object which is currently in editing focus. The representation and selection of the action objects (as objects to which the action of the dimension relates) may form or represent a third layer of the user interface, consistent with the present invention.

At first, a process step description may be purely textual. For example, it may constitute a work instruction in the sense of what has to be done by which means in a work step. One advantage of the textual description is initially that it provides an understanding of the objectives, reasons and procedure for the activities to be performed in conjunction with this process step. However, there is a considerable media discontinuity between the documentation and the execution of the activity. For the execution of the activity described and the use of tools required to perform this activity, these tools must first be found (files on the network, access to application systems, etc.) and then the appropriate execution context must be created for the tool.

Embodiments of the user interface design described herein may help to minimize the effort required for changing between the description and execution of the activity, by embedding connectors for the tools in a special area of the description dimension. By activating the connectors, a user is directly guided to the corresponding document, application system or specific functional cover for this process step without the user having to know where the document is located or which function is to be started. The following figure shows an example of the design of the process design and the design of the list of connectors.

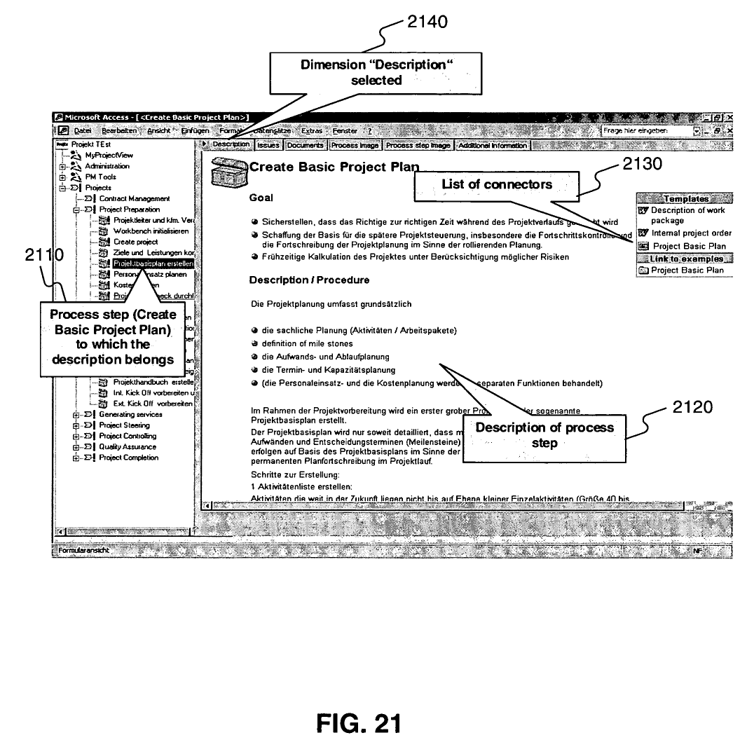

FIG. 21 is an exemplary GUI of embedding of the list of connectors in an action dimension “Process Step Description,” consistent with the present invention. In this implementation, the list of connectors is located at the left-hand edge of the visible area. However, different areas may also be selected. The process step 2110 is first selected. The dimension “Description” 2140 is then selected and the list of connectors 2130 is displayed. The description of the process step 2120 is also displayed.

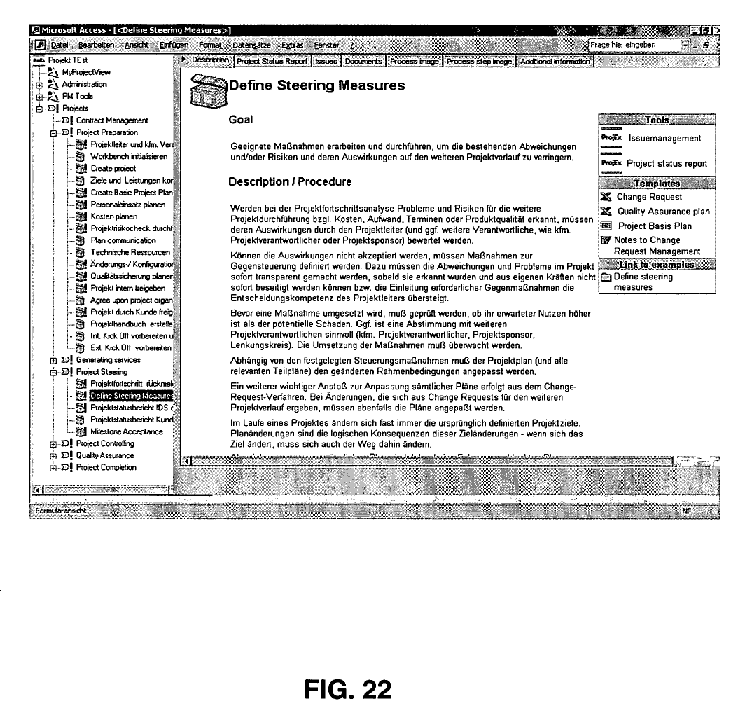

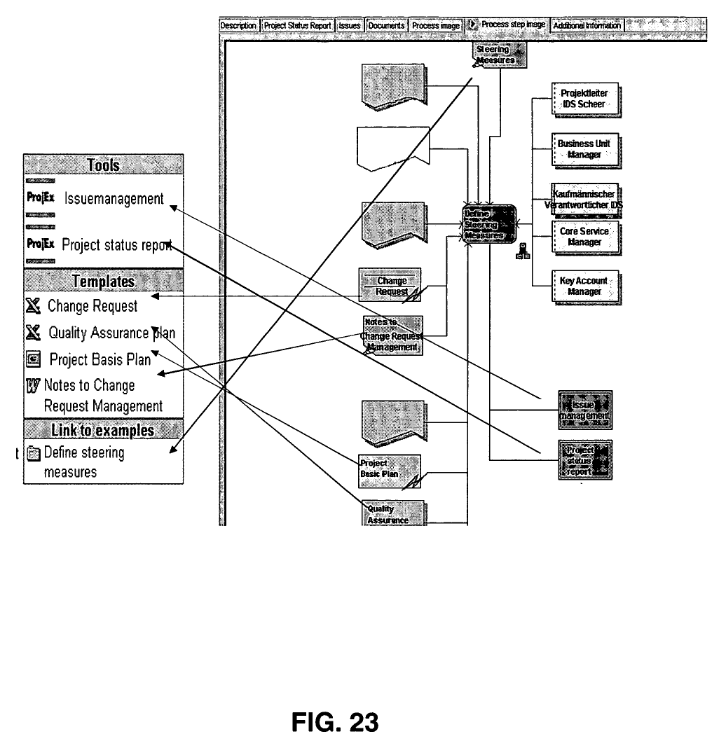

FIG. 22 is an exemplary GUI of a process step with a list of connectors with three segments (tools, templates, examples). The number of segments results from the type of usage and considerations with regard to clarity. In the referenced implementation, a total of four segments were selected in addition to the visible ones in FIG. 23 and also the segment “Checklists.” Segments which do not have any connectors are hidden. If the action dimension does not have any connectors, a connector box is not displayed. The connectors are part of the process design. The segment assignment of the connectors is carried out on the basis of a specifically reserved data field of the object that represents the connector.

Representation of Connectors

Consistent with the present invention, each entry in the list of connectors may represent a connector. The connector can be represented by a hyperlink with a name, such as a name with the following structure:
<icon><optional: type of application system><identifier><optional [<transaction code>]<icon>:

The icon is set depending on the type of application system or type of file. If the type of application system is a system known to the importer, (e.g., the importer engine described in co-pending application (Attorney Docket No. 09268.0004) which is incorporated by reference above), this type is represented by the system's default icon.

If, on the other hand, the connector represents a specific type of file which is known to the (e.g., Microsoft Office files, Acrobat Reader files, file directories or Internet forms), the default application icon is represented as a connector icon. In all other cases, a default icon with the meaning “unknown file type” may be used. As every connector preferably has an icon, the icon has a double function: it is a list symbol and type marker at the same time.

<type of application system>: In all cases in which the connector represents an element in an application system that is not known to the importer, the type of application is represented in textual form. Textual representations may also be used in an application system which supports various file types (e.g., an entry on an Intranet, where the icon represents the file type and the identifier “Intranet:” represents the type of application system, i.e., it is, for example, a file of the type Excel to be loaded from the Intranet). In all other cases, the application system type identifier is omitted.

<identifier>: Logical name of the file or application system element (e.g., form), as defined in the process design as he name of the object.

<transaction code>: Is displayed as a subaddress with systems which enable entry via subaddresses (e.g., SAP).

For purposes of illustration, FIG. 23 is an exemplary GUI showing a relationship between connectors in the process design and within the action dimension “Description,” consistent with the present invention. As shown in FIG. 23, different graphical symbols of design objects on the right hand side are depicted as different categories on the left hand side. The different graphical symbols may have different functionality. For example, a user may click on the “Change Request” template and a template is opened. Then, the user may click on “Define Steering Measures” icon and a list of exemplary documents is shown.

Mode of Operation of Connectors p As the connectors may be implemented as hyperlinks, there are two statuses: normal and highlighted. The second status indicates that the connector is in the selection focus of the mouse pointer (mouse pointer passes over it). This may be shown optically to a user by a change in color.

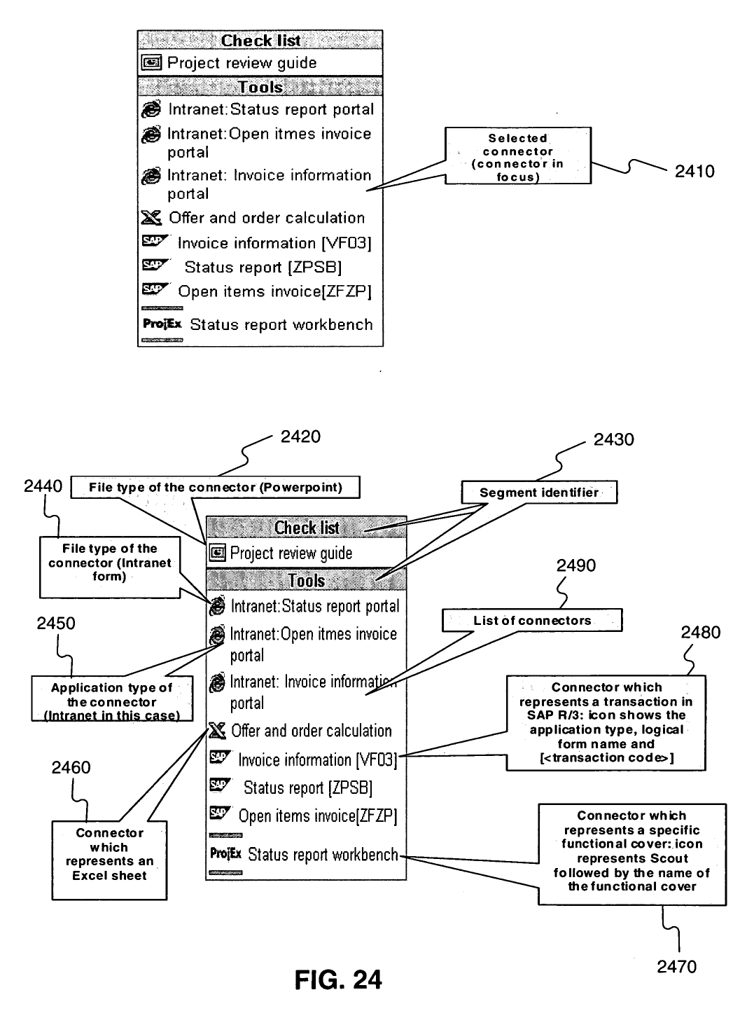

FIG. 24 provides exemplary GUIs showing a marker within the list of connectors, consistent with the present invention. The GUI may show the file type of a connector 2420 as a PowerPoint or the file type of the connector on Intranet 2440, the application type of a connector 2450, a segment identifier 2430, a list of connectors 2490, any transaction connectors 2480, the connector which represents an Excel spreadsheet 2460, and the connector which represents a specific functional cover 2470.

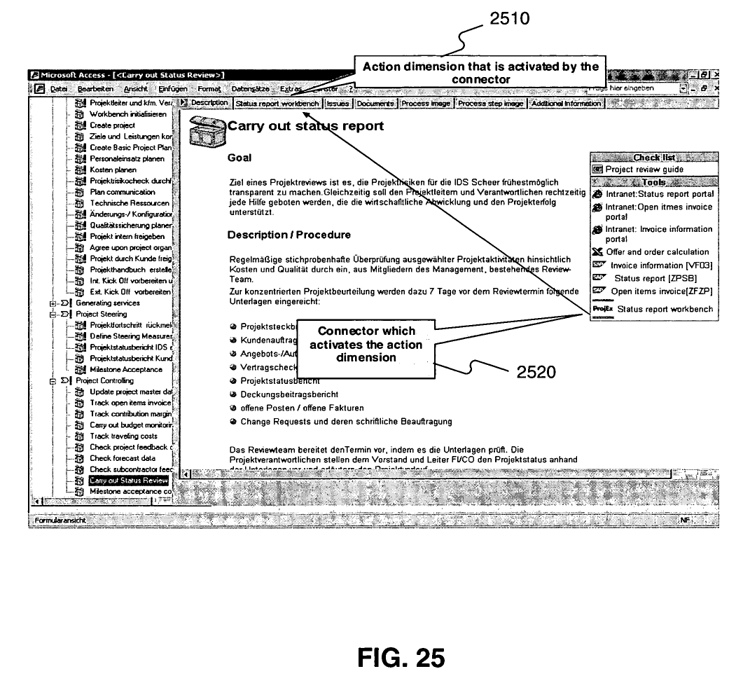

If a connector of this type is activated, the action dimension changes. For instance, it may change to the action dimension which is part of the specific functional cover of the process step and may be represented by the connector, as shown in the example of FIG. 25.

Original hyperlinks (Internet or Intranet addresses) are not handled further by the connector handler. The action Navigate is carried out by control as a normal hyperlink in Microsoft Internet Explorer. The Internet page is then embedded in the form of the action dimension. Backward functionality allows navigation back to the original page.

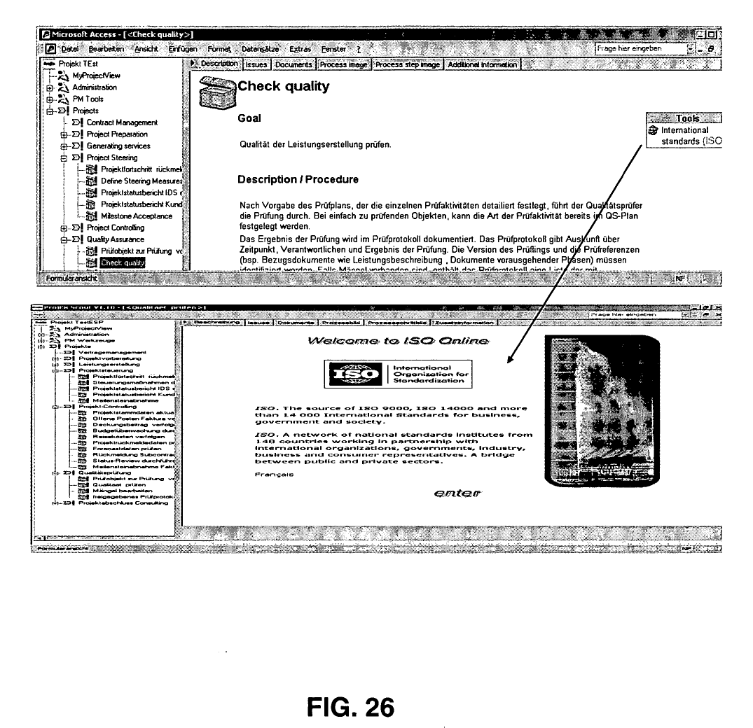

FIG. 26 is an exemplary illustration of a mode of operation of the connector type “original hyperlink,” consistent with the present invention. In this example, when the user clicks on the tool “Normative principles,” the homepage of the ISO organization is loaded.

In the case of connectors that represent templates, two types of templates may be provided with regard to localization: Templates with an absolute address and templates with a relative address. Templates with an absolute address may be loaded without further processing by the connector handler, in the same way as original hyperlinks. Alternatively, they can be loaded embedded in the control of the action dimension or in a separate application.

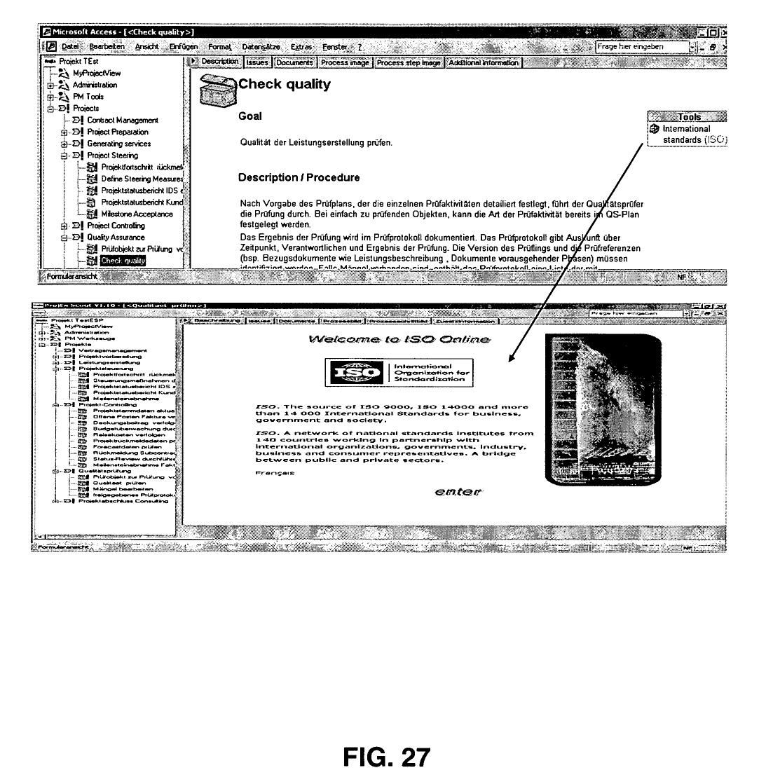

FIG. 27 is an exemplary illustration of a case of connectors that represent templates, consistent with the present invention. In this example, there are again two types of templates with regard to localization: Templates with an absolute address and Templates with a relative address. Here, templates with an absolute address may be loaded without further processing by the connector handler in the same way as original hyperlinks. Alternatively, they can be loaded embedded in the control of the action dimension or in a separate application.

Documents with a relative address may be divided into one or more parts. For example, they may consist of an address variable and the actual file name (e.g., %PROJECTDIR%\Template.dot).

Consistent with the present invention, the connector handler dissolves the address variable into the effective address of the template by replacing it with the directory path (e.g., which was set by the administrator in the basis data of the importer). There are different address variables and different directory paths (e.g., for example, central and decentralized documents, templates, etc.). This concept enables all addresses at a centralized position to be rerouted to new directories.

If a document is generated from a template that was provided in this way, it is also assigned to the process step to which the connector belongs, as if it had been generated from the standard functional cover “Documents” of this process step.

The connector handler recognizes that the file is, for example, a Microsoft Word, Powerpoint or Excel template. If this is the case, the user is requested to specify the meta information (name, subject, etc.) for the document and it is assigned to the process step.

Just as with documents that were opened from the action dimension “Documents,” the document is searched through for text marks (subaddress) after opening. For example, if it is a text mark that is registered in the importer (a logical name of a data field), it is automatically replaced by the contents of the data field of the importer database. Examples of these types of logical data field names include: name of project, name of customer, name of processor, project start data, etc.

Intranet forms to which no parameters are transferred may be treated as original hyperlinks. In some cases, however, it may make sense to already populate in advance part of the Intranet form with data residing in, for example, the importer database. It is, however, necessary that the Intranet form allows this replacement to be made. If there is a match between the database elements and the form to be filled in, as early as the process design phase, the hyperlink address is supplemented with the name of the fields to be transferred. Example: in the hyperlink address: http://intranet.ids-scheer.de/IDSEMPLOYEES/iempdata.php?loginid=&searchcat=there are two parameters “loginid” and “searchcat.”. In this case, the connector handler will check whether these parameters are registered in the database. If this is the case, the value of the data object linked to it is determined and supplemented after the “=” character. The connector handler thus converts the generic URL into a specified URL in which the data elements and data fields of the form which the database also knows, are populated in advance. The converted hyperlink address is then started.

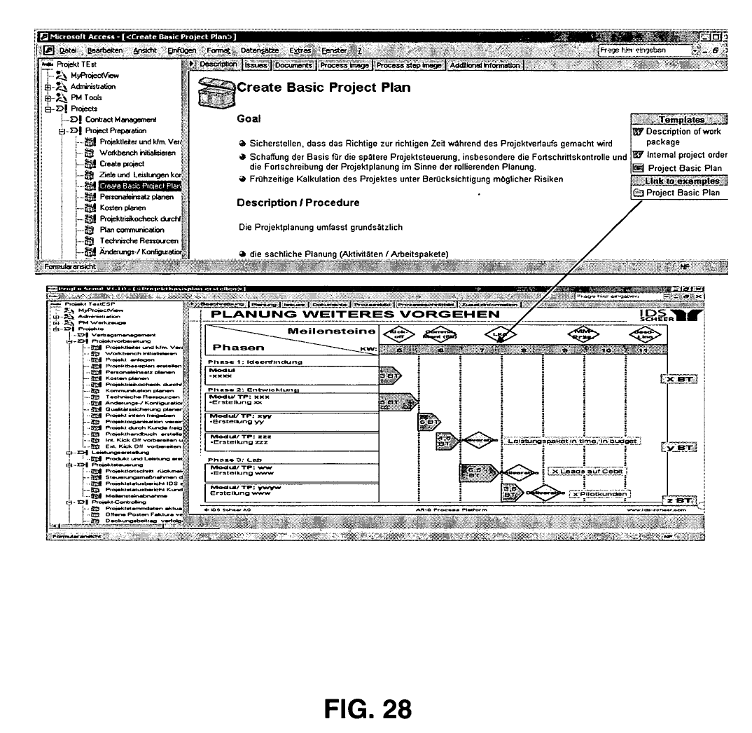

FIG. 28 is an exemplary illustration of an Intranet form that is opened. If an Intranet form is opened, the data that is known by, for example, the importer is “posted” in the form. In other words, the data fields of the form are already populated, and the user does not need to enter the data twice.

Examples are documents that provide solution samples for work results of the process step to which they are assigned. The quantity of examples in practice is very dynamic. Examples can become obsolete very quickly, more often, however, they are also supplemented by new solution samples that increase the inventory of existing solutions.

The implementation of this feature may result in two requirements with regard to support of example collections by a processor-oriented tool:
All the examples which are assigned to a process must be ordered in accordance with the structure of the process; and
It must be possible to very easily adapt the set of examples to new requirements.

To ensure the required flexibility, examples are collected in central directories on generally accessible network folders. All documents which are examples of a process step are collected in one file folder (directory). This method enables the set of examples to be adapted very quickly without the contents of, for example, the importer being affected. At the process design level, the path for this folder is connected to the process step. The path may be an absolute or relative path.

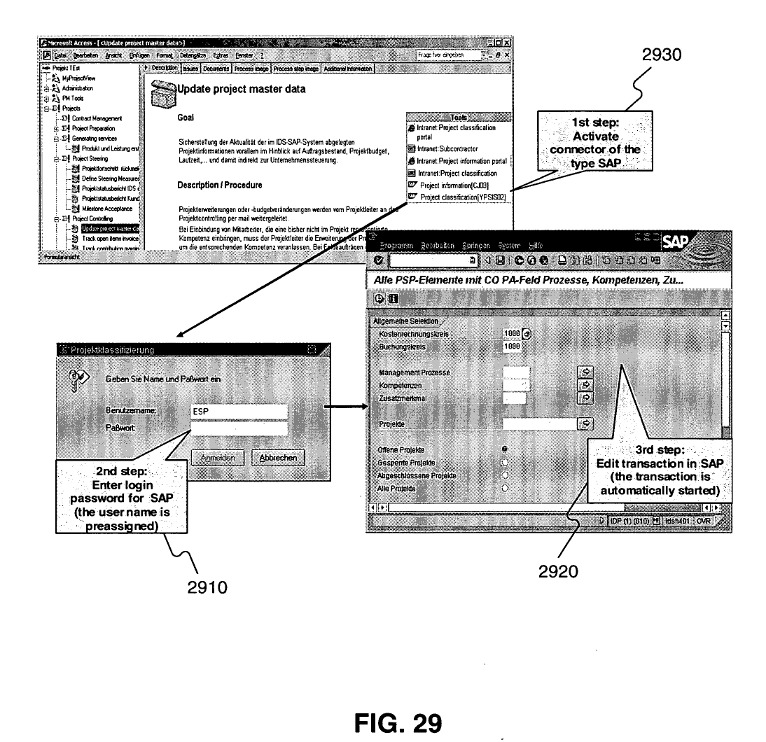

With this tool type, the connector handler represents the contents of the file folder in the usual manner for Windows Explorer, for example. The user can open the document and use the example by double clicking on the document. By way of example, FIG. 29 is an exemplary illustration of a route for process design using exemplary files.

Synchronization of the Navigation Window and Detailed Window

Consistent with the present invention, the process implementation system 200 may also provide synchronization of selection in the navigator (which process step has the focus) with the action frame. Both the process frame and the process detail page each have exactly one object in focus. For example, in the case of the process frame it is the selected process step, and in the case of the detail page, it is the selected dimension.

There are therefore two focuses and the principle of focus constancy applies for each of these focuses: the focus on an object is maintained until the user explicitly changes the focus or until the object that has the focus no longer exists. In addition, the principle of focus marking applies: A uniform method indicates which object has the focus.

A distinction may be made between two different directions of synchronization: forward and backward synchronization. The term “forward synchronization” refers to a more frequent method of changing the process step selection by the user and the resulting change of contents in the action framework. In some cases, the reverse case can also make sense: an operation in the action framework initiates a change of the process step. It may make sense, for example, when there is a relationship between process steps (e.g., if a reference is made in a description text to the subsequent step). It may, however, also make sense if branching from the planning element to the associated process step is to be effected in the planning tree (which contains the entire planning structure). A further case involves branching, from overview functionality (e.g., display a list of all documents), from an element belonging to a process step (e.g., document, issues, template, etc.) to the process step to which it belongs.

As the navigator and detail area are initially completely separate from one another, they have to be synchronized with regards to the program. It must be ensured that the current page is always loaded when the process step is changed. Three technical components are required for this: Event handler, Global storage area for exchanging focus information, and Loader for setting up the detail page.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed:

1. A computer-generated user interface for use in a process implementation environment, comprising:
a first area for displaying a hierarchical structure, the hierarchical structure defining of one or more processes and being navigated by a user to select among the one or more processes; and
a second area for displaying one or more actions, wherein the actions are user-selectable and are displayed in the second area based on the process selected by the user.

2. The computer-generated user interface of claim 1, wherein the one of the one or more processes may be represented in a vertical relationship or horizontal relationship to the rest of the other processes.

3. The computer-generated user interface of claim 1, wherein each of the processes is represented with at least one of an icon, an identifier, and additional information associated with each of the processes.

4. The computer-generated user interface of claim 3, wherein the additional information comprises at least one of a type of each process, a processing status of each process, and an obligation of each process.

5. The computer-generated user interface of claim 4, wherein the type is one of a phase, work package, and activity, and wherein the processing status if one of active, inactive, critical, and completed, and further wherein the obligation is one of optional and mandatory.

6. The computer-generated user interface of claim 1, wherein the first area includes a customizing mode, and wherein the customizing mode is activated with a context menu.

7. The computer-generated user interface of claim 6, wherein each process consists of one or more process steps, wherein each process step includes a process step status that is either activated or deactivated.

8. The computer-generated user interface of claim 7, wherein the process step status can be changed to activated or deactivated with a context menu.

9. The computer-generated user interface of claim 7, wherein a process step status that is deactivated is represented by a different icon in the hierarchical structure than a process step that is activated.

10. The computer-generated user interface of claim 7, wherein the hierarchical structure includes at least one of structure changing operations, process step related operations, and other operations.

11. The computer-generated user interface of claim 10, wherein the structure changing operations include adding a new process to the hierarchical structure, de-activating a process, and moving a process to a different position in the hierarchical structure.

12. The computer-generated user interface of claim 10, wherein the process step related operations include renaming a process step, modifying a process step property, and changing a process step status to complete.

13. The computer-generated user interface of claim 7, wherein each process step is represented by a structure item.

14. The computer-generated user interface of claim 13, wherein the structure item is one of a generic item, original item, derived item or link.

15. The computer-generated user interface of claim 14, wherein a new process step may be added by one of generating a new structure item, copying an existing structure item, or generating a link to the structure item.

16. The computer-generated user interface of claim 13, wherein the structure item may be activated or deactivated.

17. The computer-generated user interface of claim 1, wherein the one or more actions are activated by selecting the one or more actions, wherein the form presenting the selected action is brought to the foreground of the second area and overlays any other forms.

18. The computer-generated user interface of claim 1, wherein the one or more actions are represented by a tab in the second area.

19. The computer-generated user interface of claim 1, wherein the one or more actions is selected from a list comprising a description page, a planning page, an issue page, a document page and an additional information page.

20. The computer-generated user interface of claim 1, wherein the one or more actions are represented by a dimension identifier.

21. A computerized method for implementing a process using a computer-generated user interface, comprising:
identifying a process within a hierarchical structure in a first area, the hierarchical structure defining one or more processes and being navigated by a user to select among the one or more processes; and
displaying one or more actions based on the identified process in a second area, wherein the actions are user-selectable.

22. The computerized method of claim 21, wherein each of the processes is represented with at least one of an icon, an identifier, and additional information associated with each of the processes.

23. The computerized method of claim 22, wherein the additional information comprises at least one of a type of each process, a processing status of each process, and an obligation of each process.

24. The computerized method of claim 23, wherein the type is one of a phase, work package, and activity, and wherein the processing status if one of active, inactive, critical, and completed, and further wherein the obligation is one of optional and mandatory.

25. The computerized method of claim 21, wherein the first area includes a customizing mode, and wherein the customizing mode is activated with a context menu.

26. The computerized method of claim 25, wherein each process consists of one or more process steps, wherein each process step includes a process step status that is either activated or deactivated.

27. The computerized method of claim 21, wherein the one or more actions are activated by selecting the one or more actions, wherein the form presenting the selected action is brought to the foreground of the second area and overlays any other forms.

28. The computerized method of claim 21, wherein the one or more actions are represented by a tab in the second area.

29. The computerized method of claim 21, wherein the one or more actions is selected from a list comprising a description page, a planning page, an issue page, a document page and an additional information page.

30. The computerized method of claim 21, wherein the one or more actions are represented by a dimension identifier.

31. A computer-readable medium containing instructions for controlling a computer system to perform a method for implementing a business process, the computer system having a processor for executing the instructions, the method comprising:
identifying a process within a hierarchical structure in a first area of a user interface, the hierarchical structure defining one or more processes and being navigated by a user to select among the one or more processes; and
displaying one or more actions based on the identified process in a second area of the user interface, wherein the actions are user-selectable.

32. The computer-readable medium of claim 31, wherein each of the processes is represented with at least one of an icon, an identifier, and additional information associated with each of the processes.

33. The computer-readable medium of claim 32, wherein the additional information comprises at least one of a type of each process, a processing status of each process, and an obligation of each process.

34. The computer-readable medium of claim 33, wherein the type is one of a phase, work package, and activity, and wherein the processing status if one of active, inactive, critical, and completed, and further wherein the obligation is one of optional and mandatory.

35. The computer-readable medium of claim 31, wherein the first area includes a customizing mode, and wherein the customizing mode is activated with a context menu.

36. The computer-readable medium of claim 31, wherein each process consists of one or more process steps, wherein each process step includes a process step status that is either activated or deactivated.

37. The computer-readable medium of claim 31, wherein the one or more actions are activated by selecting the one or more actions, wherein the form presenting the selected action is brought to the foreground of the second area and overlays any other forms.

38. The computer-readable medium of claim 31, wherein the one or more actions are represented by a tab in the second area.

39. The computer-readable medium of claim 31, wherein the one or more actions is selected from a list comprising a description page, a planning page, an issue page, a document page and an additional information page.

40. The computer-readable medium of claim 31, wherein the one or more actions are represented by a dimension identifier.
